(19) United States
(12) Patent Application Publication
(10) Pub. No.: US 2005/0120947 A1
(43) Pub. Date: Jun. 9, 2005

(54) Coating apparatus and coating method

(75) Inventors: Yosuke Sone, Tokyo (JP); Takahiko Nojima, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Photo Imaging, Inc.

(21) Appl. No.: 11/001,920

(22) Filed: Dec. 2, 2004

(30) Foreign Application Priority Data
Dec. 9, 2003 (JP) JP2003-409981
Jan. 23, 2004 (JP) JP2004-015480

(51) Int. Cl. B05C 5/00; B05C 15/00

(52) U.S. Cl. 118/300; 118/325

(57) ABSTRACT

A coating apparatus comprising: a slot nozzle spraying apparatus provided with a pair of inner die blocks and outer die blocks at the outside of said pair of inner die blocks, having a coating solution nozzle formed between said pair of inner die blocks, and gas nozzles constituted between one inner die block and outer die block adjacent thereto, and between another inner die block and outer die block adjacent thereto, wherein, angle β between the solution flow passage of said coating solution nozzle and the gas flow passage of one of said gas nozzle is 15-60 degree.

### BACKGROUNG OF THE INVENTION

The present invention relates to a coating apparatus and a coating method in which a coating solution is coated by being sprayed as liquid drops.

Heretofore, desired has been a coating method which provides a thin layer with high precision of layer thickness, small drying load and high productivity.

A coating structure, which requires a thin layer having a very precisely uniform layer thickness applied on constituent layers, includes variety of types, and for example, a void type recording medium for inkjet described below.

A void type recording medium is preferably utilized in an inkjet recording method for an out put requiring a high quality texture like silver halide photography such as glossy feeling, glazing feeling and deep feeling, a porous ink absorptive layer provided with micro void structure comprising primarily a hydrophilic binder and micro-particles being formed on a non-absorptive substrate such as resin coated paper and polyester film, and ink is made to be absorbed by these voids. As micro-particles, inorganic or organic micro-particles are known, however, inorganic micro-particles provided with more minuteness and higher glossiness are generally utilized.

For the above-described porous ink absorptive layer, proposed is utilization of each additive such as stable micro-particles of generally not more than 0.1 μm in size forming porous structure to achieve high coloration and glossiness; a hydrophilic binder provided with a low swelling property to enhance retention capability of micro-particles as well as not to decrease ink absorptive rate; a cross-linking agent for a hydrophilic binder to improve ink absorptive rate or a water-resistance of the layer; a surfactant or a hydrophilic polymer distributed on the surface to achieve an optimum printing dot diameter; a cationic fixing agent and a polyvalent metal compound to improve anti-bleeding and water-resistance of a dye image; an anti-fading agent to restrain fading due to light or an oxidizing gas; a fluorescent whitening agent or a tone adjusting agent (such as a reddishness providing agent and a bluing agent) to improve a white background; a matting agent or a sliding agent to improve a sliding property of the surface; various types of oil components, latex particles or a water-soluble plastisizer to provide flexibility to a porous ink absorptive layer; various types of inorganic salts (poly-valent metal salts) to improve anti-bleeding, water resistance or weather-proofing; and acids or alkalis to adjust the surface pH of a porous ink absorptive layer.

However, many additives are often subjected to various limitations such as selection and a using amount of materials with respect to stability of manufacturing processes such as avoiding aggregation of micro-particles, in the case of adding each additive described above into a coating solution to form a porous ink absorptive layer.

Therefore, proposed has been a method in which additives being subjected to the above limitations are not contained in a coating solution of a porous ink absorptive layer but said coating solution is firstly coated on a substrate as a constituent layer followed by over-coating a coating solution containing the additives described above on the aforesaid constituent layer before the falling rate drying, or a method in which a coating solution containing additives is over-coated by an inline mode after a water content of a constituent layer reaches less than a void volume of the dried porous layer. The aforesaid additives contained in a coating solution of an over-coating layer is expected to suitably penetrate into a constituent layer having been applied in advance to work as a function providing compound to provide preferable functions. Since the purpose is basically to impregnate function providing compounds into a porous ink absorptive layer, overcoat layer may be very thin and is preferably very thin.

As a method to coat such an over-coat layer at a uniform thin thickness, the applicant of this invention has proposed a method to spry a coating solution as liquid drops onto a member to be coated by use of a slot nozzle spraying apparatus and a detail of manufacturing conditions of an inkjet recording sheet in JP-A (hereinafter, JP-A refers to Japanese Patent Publication Open to Public Inspection) Nos. 2004-906, 2004-90330, 2004-106378 and 2004-106379.

However, to spray a coating solution as liquid drops onto a member to be coated is effective to make a very thin coating layer thickness, while there may be generated streaks along the transport direction, spot-like coating defects, or cross-streak and/or spot coating unevenness especially in the case of high speed coating.

### SUMMARY OF THE INVENTION

According to one embodiment of the present invention, a coating apparatus is provided, said apparatus comprising a slot nozzle spraying apparatus provided with a pair of inner die blocks and outer die blocks at the outside of said pair of inner die blocks, having a coating solution nozzle formed between said pair of inner die blocks, and gas nozzles constituted between one inner die block and outer die block adjacent thereto, and between another inner die block and outer die block adjacent thereto, and angle β between the solution flow passage of said coating solution nozzle and the gas flow passage of one of said gas nozzles can be 15-60 degree.

Another embodiment is a coating apparatus comprising a slot nozzle spraying apparatus provided with a pair of inner die blocks and outer die blocks at the outside of said pair of inner die blocks, having a coating solution nozzle formed between said pair of inner die blocks, and gas nozzles constituted between one inner die block and outer die block adjacent thereto, and between another inner die block and outer die block adjacent thereto, and angle α formed by planes of said outer die blocks located at the position opposing to a member to be coated can be 170-240 degree.

In other embodiment is a coating apparatus comprising a slot nozzle spraying apparatus provided with a pair of inner die blocks and outer die blocks at the outside of said pair of inner die blocks, having a coating solution nozzle formed between said pair of inner die blocks, and gas nozzles constituted between one inner die block and outer die block adjacent thereto, and between another inner die block and outer die block adjacent thereto, and each width of the planes of said pair of inner die blocks opposing a member to be coated is not more than 1 mm, and each width of the planes of said pair of outer die blocks opposing a member to be coated is 0.1-50 mm.

### BRIEF DESCRIPTION OF THE DRAWINGS

FIG. 1 is a schematic drawing to explain a coating method of this invention.

FIG. 2 is a schematic cross-sectional drawing to show an example of a slot nozzle spraying apparatus including a slot nozzle spray portion.

FIG. 3 is a schematic drawing to explain a slot nozzle spray portion and the state of formation and flying of liquid drops formed therein.

FIG. 4 is a schematic cross-sectional drawing to show a constitution of a slot nozzle spray portion.

FIG. 5 is a schematic cross-sectional drawing to show another constitution of a slot nozzle spray portion.

FIG. 6 is a schematic cross-sectional drawing to show further another constitution of a slot nozzle spray portion.

FIG. 7 is a schematic cross-sectional drawing to show further another constitution of a slot nozzle spray portion.

FIG. 8 is a schematic cross-sectional drawing to show a further another example of a slot nozzle spray portion.

FIG. 9 is a schematic drawing to show an example of a view from the side of coating solution nozzle C of the slot nozzle spray portion of FIG. 2.

FIG. 10 is a schematic drawing to show another example of a view from the side of coating solution nozzle C of the slot nozzle spray portion of FIG. 2.

FIG. 11 is a detailed oblique view drawing of an example of a slot nozzle spray potion.

FIG. 12 is a drawing to show an example of a coating manufacturing line in which a slot nozzle spraying apparatus is arranged.

### DETAILED DESCRIPTION OF THE PRESENT INVENTION

The inventor estimated that streak and spot coating defects, or cross-streak and spot coating unevenness is controlled by change of a liquid drop landing ratio and a state of particle minuteness due to adhesion of a coating solution on the slot nozzle spray portion, and, as a result of studies on a coater constituting a slot nozzle spraying apparatus to achieve stable coating in this method, has found that not only the shape of a slot nozzle spraying apparatus but also the surface characteristics of materials constituting a slot nozzle spraying apparatus are providing great influence.

That is, the inventor has found that by designing such as an angle between a coating solution ejecting outlet and a gas gushing outlet, an angle of external die blocks constituting a gas ejecting outlet, a distance between a coating solution ejecting outlet and a gas gushing outlet and a width of an external die block to satisfy the optimum conditions, with respect to a shape of a coater portion constituting a slot nozzle spraying apparatus, adhesion of a coating solution and insufficient micro-particle formation are depressed to enable stable spraying of coating solution liquid drops, and resulting in decrease of coating defects and coating unevenness to achieve this invention.

Further, the inventor has found that by providing a water repellant surface treatment on the surface adjacent to an ejecting outlet of said coating solution nozzle or gas nozzle in said slot nozzle spraying apparatus facing to a member to be coated, and more preferably, in addition to this, by providing a water repellant surface treatment on the gas flow path wall of a gas nozzle or the liquid flow path wall of a coating solution nozzle, continuous and stable spraying of a coating solution is possible to decrease coating defects and coating unevenness.

First, a slot nozzle spraying apparatus, which is a coating apparatus of this invention, will be detailed referring to drawings. However, a coating apparatus of this invention is not limited to the constitutions shown by the exemplary drawings.

In this invention, a member to be coated is transported, and a coating solution is coated on said member to be coated by a gas being collided with said coating solution to form liquid drops and performing spraying, by use of a slot nozzle spraying apparatus provided with a coating solution nozzle which supply a coating solution and a gas nozzle adjacent to the opening edge of said coating solution nozzle which gushes a gas, over the coating width in the direction crossing the transport direction of said member to be coated.

A member to be coated herein means an object to be coated with a coating solution being made into a liquid drops to be sprayed by use of a coating method and apparatus of this invention, and the form, being not limited, is preferably a long roll band shape support, on which a constituent layer is already provided, and for example, is an inkjet recording sheet provided with such as an ink absorptive layer, however, it is not limited thereto. A member to be coated may be a plate form support or those provided with a steric shape, and any provided that a part to be coated has an area.

Further, in this invention, a member to be coated is transported relative to a coating solution nozzle of a coating apparatus and continuous coating manufacturing is performed. A coating solution nozzle of a coating apparatus is provided with at least a length corresponding to a coating width (indicates a length of a coating portion of the aforesaid member to be coated in the direction crossing to the transport direction of a member to be coated) of a member to be coated, coats a coating solution on a member to be coated only by transporting a member to be coated relative to a coating apparatus, by being arranged so as to cross the transport direction of a member to be coated. In the case of a member to be coated being a long roll band shape support, it is preferable to transport a band shape support itself in the longitudinal direction of a band shape support and to arrange a coating solution nozzle of a coating apparatus in the width direction (the direction crossing the longitudinal direction with a right angle) of a band shape support. A very thin coating layer can be coated at a uniform layer thickness without much drying load by transporting a support to be coated in one direction relative to a coating apparatus and making a coating solution into liquid drops to be sprayed over the coating width.

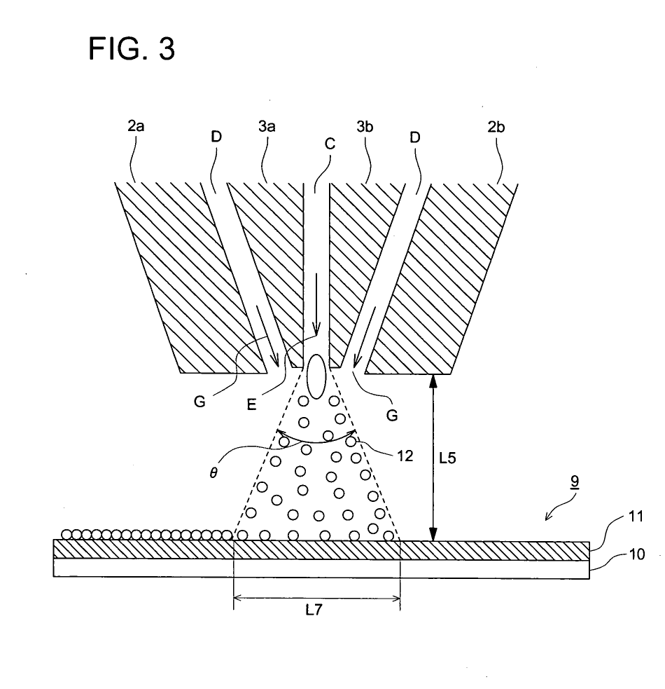

Further, liquid drops sprayed from a coating nozzle of a coating apparatus preferably satisfy the following conditions with respect to the coating width direction:
1. The diameter distribution of liquid drops is uniform.
2. The area region of liquid drops falling on a member to be coated is uniform as a falling length in the transporting direction (L7 of FIG. 3).
3. The spreading angle of falling on a member to be coated is uniform.
4. The collision speed of falling on a member to be coated is uniform.

Thereby, more uniform coating thickness can be assured.

A distribution of a liquid drop diameter being uniform in the coating width direction specifically refers to that a variation of a mean liquid drop diameter in the coating width direction, when coating is performed for a definite time duration, is not more than ±20% and more preferably not more than ±10%.

A variation of a mean liquid drop diameter can be measured by use of a laser diffraction type particle size distribution analyzer, and calculated. Specifically, it is performed according to the following measurement method.

First, a coating solution is sprayed from a spraying device of such as a slot nozzle spraying apparatus that sprays a coating solution as liquid drops, and the spraying state is stabilized. It can be stabilized by continuing to spray for a predetermined time, since it is not stable immediately after start of spraying.

Next, a mean liquid drop diameter is measured at 5 points at same intervals in the coating width direction by use of Spray Tech RTS5123 (manufactured by Malvan Corp.) as a laser diffraction type particle size distribution analyzer with respect to a liquid drop group in a stable spraying state. The both edges (coating edges) in the coating width direction are not counted as an effective coating width since a spraying density generally becomes extremely low. Therefore, the both edges of an effective coating width are adopted as the both two edge points of measurement. Specifically, a measurement points at 1 cm inside from the coating edges are designated as the both two edge points of measurement, and 3 points at same intervals inside thereof are included to make the total 5 points as measurement points. A coefficient of variation is calculated from mean liquid drop diameters measured at these 5 points.

Herein, a mean liquid drop diameter, which can be simply measured by use of Spray Tech RTS5123, indicates a liquid drop diameter at the position of 50% based on a volume percent when each liquid drop diameter of a liquid drop group at the aforesaid measurement points is measured and the liquid drop diameters are accumulation plotted by making a liquid drop diameter as the abscissa.

Further, a falling length in the transporting direction of an area region of liquid drops falling on a member to be coated being uniform refers that the variation of said length in the coating width direction is not more than ±10% and more preferably not more than ±5%.

A spreading angle of falling on a member to be coated being uniform refers that a variation of a spreading angle of liquid drops falling on a member to be coated, in a coating width direction based on a coating nozzle of a coating apparatus as a standard point, is not more than ±10% and more preferably not more than ±5%.

Further, to make a collision velocity of falling on a member to be coated uniform, a spraying rate of a coating solution having been made into micro-particles should be uniform.

To achieve such uniform spraying as described above, this invention is characterized by utilization of a slot nozzle spraying apparatus. A slot nozzle spraying apparatus is provided with a plural number along the coating width direction of coating solution nozzle holes, which ejects a coating solution. Each coating solution nozzle hole may be arranged in a row or in a zigzag way along the coating width direction. And, the apparatus is also provided with gas nozzle holes, which gushes a gas, adjacent to the aforesaid coating solution nozzle holes, and has a mechanism to form liquid drops by making a gas gushed from here to collide against a coating solution ejected from the aforesaid coating solution nozzle holes.

As a slot nozzle spraying apparatus preferably utilized in this invention, for example, one described in JP-A No. 6-170308 can be employed. In JP-A No. 6-170308, disclosed is an example in which an adhesive is coated on fibers of a disposable diaper by use of this slot nozzle spraying apparatus, and an extremely high viscous coating solution (an adhesive) falls in a fiber-form from coating solution nozzles (a coating solution ejecting portion) of a slot nozzle spraying apparatus, wherein the coating apparatus and a member to be coated (fibers) is connected by the aforesaid coating solution of a fiber-form. That is, this is different from the method of this invention that applies discontinuous liquid drops on a member to be coated. A coating solution in a fiber-form falling parallel from each of plural coating solution nozzles provided over a coating width is disturbed by a gas gushed from a gas nozzles provided adjacent to the aforesaid coating solution nozzles to be prevented from vertically falling, only resulting in landing randomly within a certain range of area on a member to be coated. Without gas nozzles, a coating solution in a fiber-form vertically falls as it is, but a coating solution can be landed more widely distributed by a gushing gas from gas nozzles. However, it gives a coated layer like Chinese noodle just being spread and placed, and cannot perform coating to respond required definitely uniform coating layer thickness over the whole of a member to be coated such as mentioned in an example of an inkjet recording sheet. Further, since it is for coating of adhesives, the coated layer is extremely thick.

Further, a slot nozzle spraying apparatus disclosed in JP-A No. 5-309310 can also be preferably utilized in this invention. The example disclosed in JP-A No. 5-309310 is for coating a hot-melt type adhesive on a member to be coated, similar to the example of the aforesaid JP-A No. 6-170308. In this method, since a coating solution (an adhesive) is extremely highly viscous, a coating solution is continuously ejected in a fiber-form on the surface of a member to be coated so that a precisely uniform layer thickness cannot be provided as well as a formed coated layer is extremely thick.

A method to increase uniformity of a spraying state over a coating width by use of a slot nozzle spraying apparatus as described above can be achieved by setting viscosity of a coating solution to relatively low and a gas pressure being gushed from gas nozzles to relatively high. Further uniformity of spraying can be increased by such as making the area of a coating solution nozzle opening edge small or the pitch of said opening edges narrow.

A viscosity of a coating solution is preferably 0.1-250 mPa·s, more preferably 0.1-50 mPa·s and furthermore preferably 0.1-20 mPa·s, and possible is spraying of uniform liquid drops over a coating width by applying a coating solution having such a low viscosity to a slot nozzle spraying apparatus.

Further, to perform spraying of uniform liquid drops over a coating width, the surface tension of a coating solution is adjusted to 20-70 mN/m, preferably to 20-50 mN/m and more preferably to 20-30 mN/m.

A gas inner pressure when liquid drops are formed by a gas being collided with a coating solution by use of a slot nozzle spraying apparatus is not less than 10 kPa, preferably not less than 20 kPa and more preferably not less than 50 kPa, with respect to easily performing uniform spraying. A flow volume of a gas is not less than 3.5 CMM/m, preferably not less than 7 CMM/m and furthermore preferably not less than 10 CMM/m.

A coating solution can be uniformly supplied on a member to be coated even with a small volume of a coating solution by spattering the solution not as a continuous fiber-form but as discontinuous liquid drops over a coating width by use of the above means. As a result, a uniform coated layer thickness can be achieved. Further, since a coating solution volume becomes small due to supply of discontinuous liquid drops on a member to be coated, a drying load is minimized.

Next, a specific form of a slot nozzle spraying apparatus utilized in this invention will be explained.

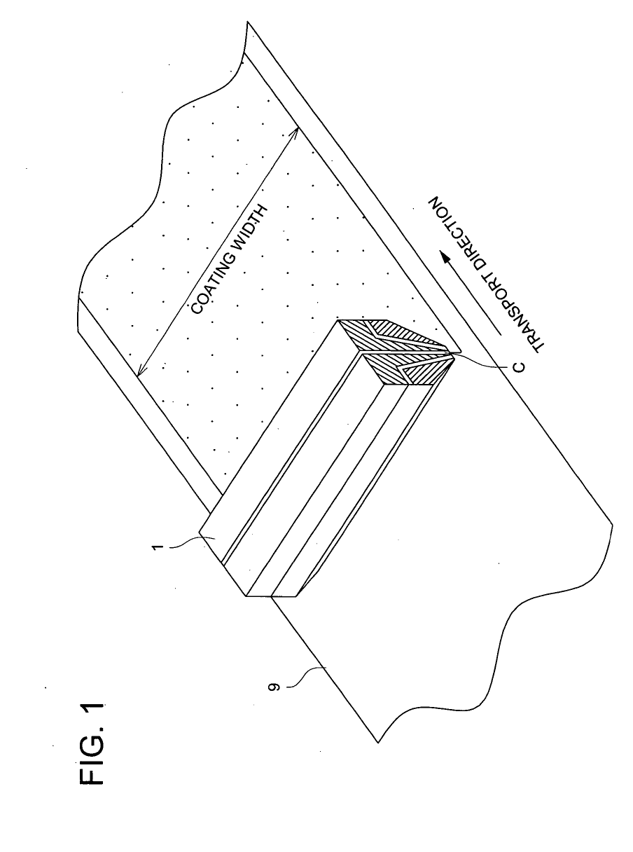

In FIG. 1, reference symbol 1 shows a slot nozzle spray portion of a slot nozzle spraying apparatus, and 9 shows a member to be coated of a long roll band-shape support type.

Member 9 to be coated is transported toward the transport direction represented by an arrow, which is a longitudinal direction of said member to be coated in the drawing, at a constant speed by means of a transport means, which is not illustrated in the drawing. Coating solution nozzle C of slot nozzle spray portion 1 is provided with a length along the width direction, which is a direction to cross the transport direction at a right angle, and arranged so as to oppose the coating surface of member 9 to be coated. A coating solution is sprayed as liquid drops from coating solution nozzle C, and landing of the liquid drops on member 9 to be coated being transported performs coating. At this time, an adhesion length of a coating solution in the width direction of member 9 to be coated corresponds to the coating width shown by arrow in the drawing. In FIG. 1, the coating width is shorter than the length in the width direction of member 9 to be coated, however, may naturally be the same as said length.

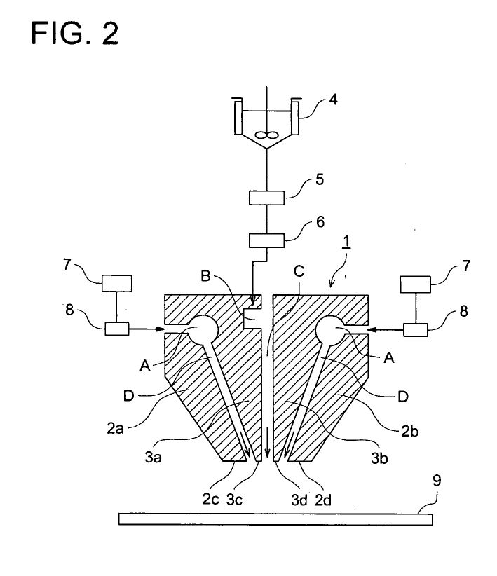

In FIG. 2, slot nozzle spray portion 1 is provided with a pair of inner die blocks 3a and 3b, and outer die blocks 2a and 2b at the outside of said pair of inner die blocks 3a and 3b, and coating solution nozzle C is formed between pair of die blocks 3a and 3b, as well as gas nozzles D are constituted between inner die block 3a and outer die block 2a, and between inner die block 3b and outer die block 2b, respectively.

That is, slot nozzle spray portion 1 is provided with pair of gas nozzles D having gas pocket A and coating solution nozzle C having coating solution pocket B. A coating solution, such as a function providing compound containing solution having a viscosity (preferably being 0.1-250 mPa·s) not to be made into a fiber-form but to be able to form liquid drops is charged in preparation vessel 4 and is supplied to coating solution pocket B via pump 5 and flow meter 6 to be guided to coating solution nozzle C. While, a pressurized air is supplied to gas pockets A of gas nozzles D from pressurized air sources 7 via valves 8. At the time of coating, a coating solution is supplied from preparation vessel 4 via coating solution nozzle C so as to make a predetermined coating amount simultaneous with blowing pressurized air from pair of gas nozzles D to make the coating solution into liquid drops, which is sprayed and ejected to be adhered on member 9 to be coated. A coating method of this invention is primarily characterized by that a coating solution can be supplied not in a fiber-form but by being sprayed as liquid minute drops. A thin layer having an extremely high uniformity can be formed at a high speed without much drying load by supplying a coating solution as minute liquid drops on the surface of member 9 to be coated.

In FIG. 3, coating solution E ejected from coating solution nozzle C is subdivided and made into liquid drops to form near spherical liquid drop particles 12, which fly and uniformly land on the surface of member 9 to be coated which is separated by gap L5. In FIG. 3, member 9 to be coated is shown as a model in which ink absorptive layer 11 as a constituent layer having been coated on substrate 10. The area range of liquid drop particles 12 of a coating solution which land on member 9 to be coated is preferably uniform always, and especially a falling length (described as falling length L7 in the drawing) in the transport direction is preferably uniform over a coating width. Further, a spreading angle θ of a sprayed liquid drop group, against a member 9 to be coated making the opening edge of coating solution nozzle C as a standard point, is preferably uniform over the coating width.

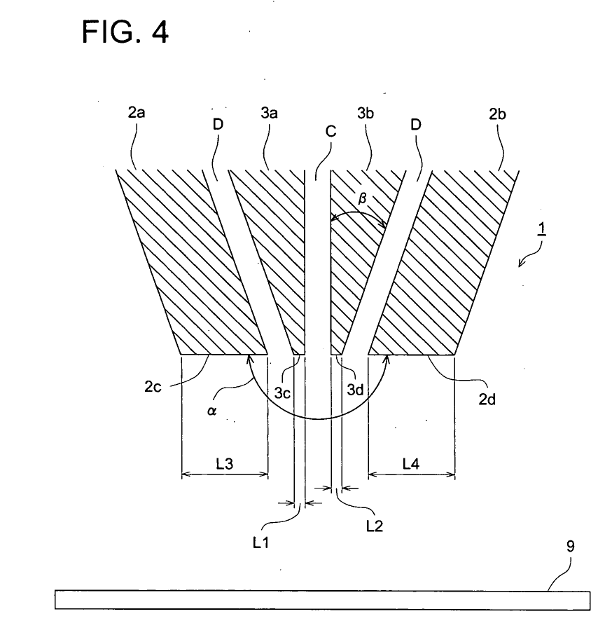

In FIG. 4, it is one of characteristics of this invention that angle β between coating solution nozzle C which is constituted of a space between inner die blocks 3a and 3b, and gas nozzles D which are constituted of a space between inner die block 3a and outer die block 2a and a space between inner die block 3b and outer die block 2b, is 15-60 degree. Specifically, in many cases, coating solution nozzle C is often arranged perpendicular to the surface of a member to be coated, and gas nozzle D is arranged by providing an inclining angle of 15-60 degree against the perpendicular direction. In this way, by arranging coating solution nozzle C and gas nozzle D at a specific angle, formation of liquid drops of a coating solution is possible and streak unevenness or coating defects are decreased, resulting in achievement of coating provided with high coating uniformity.

Further, a coating apparatus of this invention is characterized in that angle α, formed by a pair of the bottom planes of outer die blocks, which are located at the position opposing to a member to be coated, is 170-240 degree.

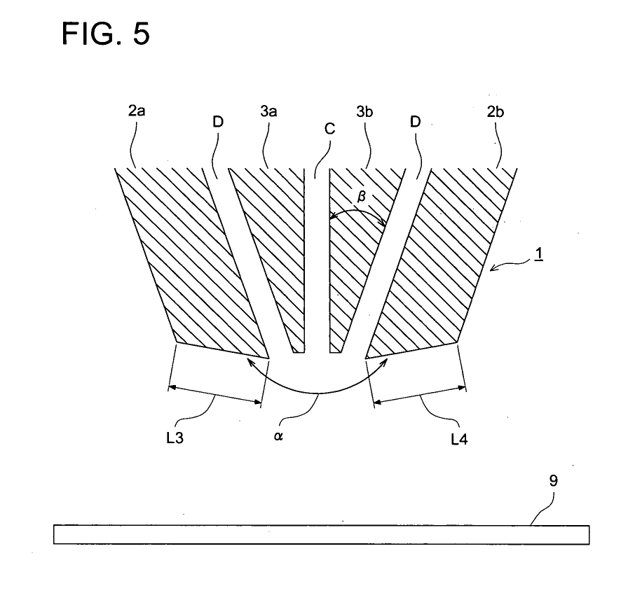

In FIG. 4, angle α formed by bottom planes 2c and 2d is 170-240 degree, when each bottom plane of outer die blocks 2a and 2b located at the position opposing to member 9 to be coated is designated as 2c and 2d respectively. In FIG. 4, a state, in which each bottom plane 2c and 2d is located horizontally against member 9 to be coated and angle α is 180 degree, is shown as an example, however, as in FIG. 5, each bottom plane 2c and 2d may also be formed in a state provided with a slope against member 9 to be coated.

In this manner, by arranging the bottom plane of a pair of outer die blocks by providing a specific angle, a stable liquid drop formation is possible and streak unevenness and coating defects are reduced resulting in achieving coating having high coating uniformity.

Further, a coating apparatus of this invention is characterized in that each width L1 and L2 of the bottom planes of a pair of inner die blocks, which is located to oppose a member to be coated, is not more than 1 mm, in addition that each width L3 and L4 of the bottom planes of a pair of outer die blocks, which is located to oppose a member to be coated, is 0.1-50 mm. That is, in FIG. 4, it is characteristic that each width L1 and L2 of bottom planes 3c and 3d is not more than 1 mm and preferably 0.2-1.0 mm, when each bottom plane of inner die blocks 3a and 3b-located opposing to member 9 to be coated is designated as 3c and 3d, respectively.

In addition to this, it is characteristic that each width L3 and L4 of bottom planes 2c and 2d is 0.1-50 mm and preferably 0.1-30 mm, when each bottom plane of outer die blocks 2a and 2b located opposing to member 9 to be coated is designated 2c and 2d, respectively.

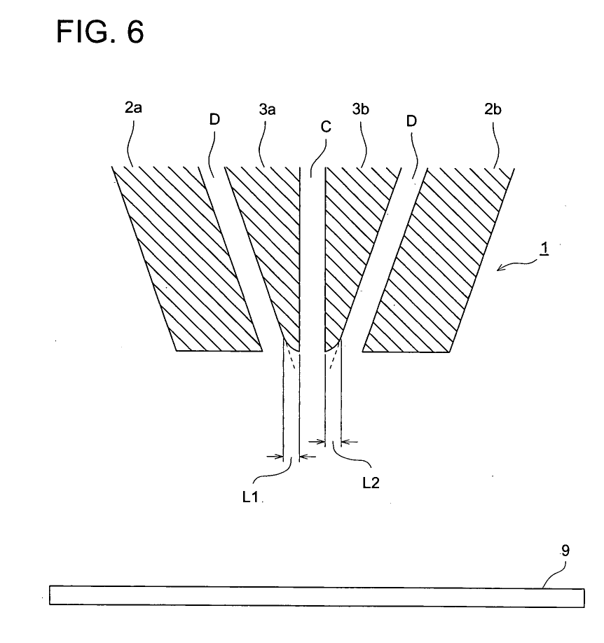

A shape of the bottom planes 3c and 3d of inner die blocks 3a and 3b according to this invention may be constituted in a state horizontal against member 9 to be coated as shown in FIG. 4, or may be provided with a curved form as shown in FIG. 6. In the case of a curved form shown in FIG. 6, L1 and L2 specified in this invention are defined as widths between contact points of the sloped planes and top edges of the vertical planes.

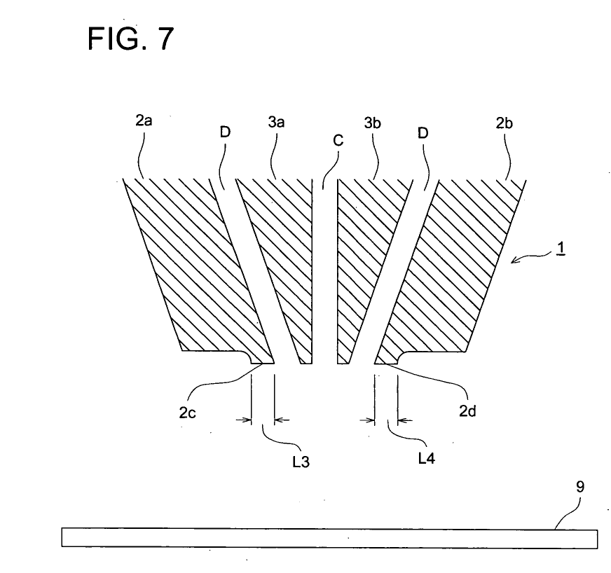

A shape of the bottom planes 2c and 2d of outer die blocks 2a and 2b according to this invention may be constituted in a state of the whole bottom plane being horizontal against member 9 to be coated as shown in FIG. 4, or may be constituted of portions adjacent to coating solution nozzle C and gas nozzle D having a form provided with a projection and bottom planes 2c and 2d may be formed in said projected region as shown FIG. 7. In this manner, by arranging a width of a bottom plane of an inner block or outer block which is located to oppose against a member to be coated according to a specific condition, stable liquid drop formation of a coating solution is possible and streak unevenness and coating defects are reduced, resulting in achievement of coating to exhibit high coating uniformity.

In a coating apparatus of this invention, the difference ΔL of distance L5 between the bottom plane of an outer die block and the surface of a member to be coated, and distance L6 between the bottom plane of an inner die block and the surface of a member to be coated, is preferably not more than 2 mm and more preferably 0.1-2.0 mm.

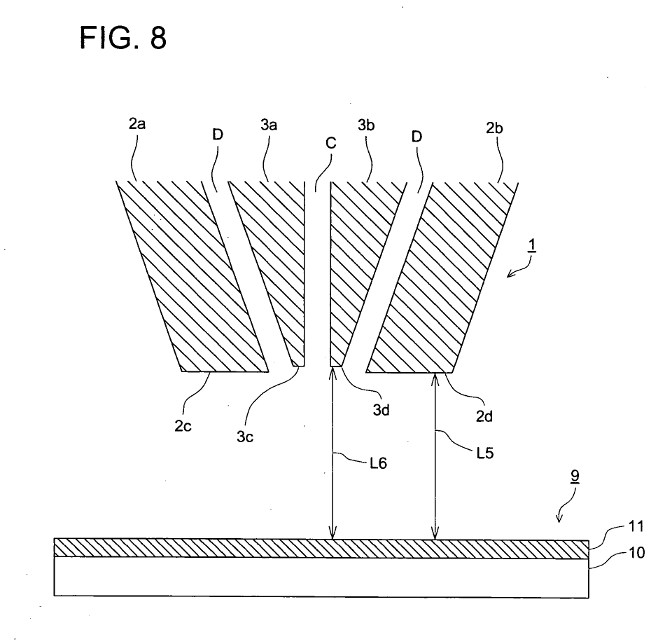

This means that, for example in FIG. 8, when a distance between each bottom plane 3c and 3d of inner die blocks 3a and 3b located to oppose member 9 to be coated and the most front surface of member to be coated is L6, a distance between each bottom plane 2c and 2d of outer die blocks 2a and 2b located to oppose member 9 to be coated and the most front surface of member to be coated is L5, an absolute vale of distance difference ΔL (L5-L6) is not more than 2 mm. Herein, the most front surface of a member to be coated in this invention means, for example, the most front surface of ink absorptive-layer 11 in the case of an inkjet recording sheet in which ink absorptive layer 11 as a constituent layer is coated on substrate 10. In this manner, by setting the difference ΔL of, a distance between the bottom plane of an outer die block and the surface of a member to be coated and a distance between the bottom plane of an inner die block and the surface of a member to be coated, in a specific condition, stable liquid drop formation of a coating solution is possible and streak unevenness and coating defects are reduced, resulting in achievement of coating provided with high coating uniformity.

In a coating apparatus of this invention including a slot nozzle spraying apparatus primarily comprising the above constitution, the surfaces adjacent to an ejection outlet of a coating solution nozzle or of a gas nozzle, which opposes to a member to be coated, have been preferably subjected to a surface water-repellant treatment.

The surfaces adjacent to an ejection outlet of a coating solution nozzle or of a gas nozzle in a slot nozzle spraying apparatus of this invention are, for example in a slot nozzle spraying apparatus shown in FIG. 2, bottom plane portions 2c, 2d, 3c and 3d of slot nozzle spray portion 1 arranged to oppose member 9 to be coated.

Further, in a coating apparatus of this invention, it is preferable to provide a surface water repellant treatment also on a gas flow passage wall of a gas nozzle and/or a liquid flow passage wall of a coating solution nozzle, with respect to furthermore effective exhibition of effects of this invention.

A gas flow passage wall of a gas nozzle in this invention refers to the wall surface which constitutes a flow passage from gas pocket A, to which pressurized air is supplied from pressurized air source 7 via valve 8, to gas nozzle D. And a liquid flow passage wall of a coating solution nozzle refers to the wall surface which constitutes a flow passage from a coating solution pocket B, to which a coating solution is supplied via pump 5 and flow meter 6, to coating solution nozzle C.

In a coating apparatus of this invention, the surfaces of the specific portions explained above of a slot nozzle spraying apparatus according to this invention have been subjected to a water-repellant treatment, and desired surface water-repellancy can be applied on each above-described specific portions, by being constituted of a material provided with water-repellancy, covering with such as a water-repellant film, or being subjected to a surface treatment by means of such as coating or evaporation with a water-repellant agent.

A surface water-repellant treatment referred in this invention means to apply a material with a treatment so as to make a contact angle against pure water of the material surface of not less than 105°. Since a material utilized in a main body of a slot nozzle spray portion of a slot nozzle spraying apparatus according to this invention is preferably constituted of a metal material and specifically preferably of a stainless steel, with respect to such as manufacturing precision and durability, a surface water-repellant treatment according to this invention is preferably performed by coating a fluorine-containing polymer on the material surface.

Fluorine-containing polymers utilized for a surface water-repellant treatment are preferably a fluorine-containing silane coupling agent and an amorphous (non-crystalline) fluorine-containing polymer.

Fluorine-containing silane coupling agents are easily available on the market, for example, from Toray Dow Corning Silicone Inc., Shinetsu Chemicals Co., Ltd., Daikin Industrial Co., Ltd. (for example, Optool DSX), Gelest Inc. and Solvey Solexis Co., Ltd., in addition to this, they can be synthesized according to synthesis methods described, for example, in J. Fluorine Chem., 79 (1), 87 (1996), Zairyo Gijutsu, 16 (5), 209 (1998), Collect. Czech. Chem. Commun., vol. 44, pp. 750-755, J. Amer. Chem. Soc., vol. 112, pp. 2341-2348 (1990), Inog. Chem., vol. 10, pp. 889-892 (1971), U.S. Pat. No. 3,668,233, JP-A Nos. 58-122979, 7-242675, 9-61605, 11-29585, 2000-64348 and 2000-144097, or in accordance with these methods.

Further, as amorphous fluorine-containing polymers, preferably utilized are fluorine-type polymers such as Cytop (manufactured by Asahi Glass Co., Ltd.), polydiperfluoroalkyl fumarate and Teflon (R) AF (manufactured by DuPont Corp.), alternate polymers of fluorine-containing ethylene and hydrocarbon type ethylene such as a alternate polymer of diperfluoroalkyl fumarate and styrene, a alternate polymer of trifluorochloroethylene and vinyl ester, a alternate polymer of tetrafluorochloroethylene and a hydrocarbon type ethylene, and analogs or derivatives thereof, and Fumarite (manufactured by Nippon Oil & Fat Co., Ltd.).

Since these fluorine-containing polymers are selectively soluble in a fluorine type organic solvent, they are dissolved in a solvent at an arbitrary concentration and coated resulting in a coating layer having excellent adhesion to each material of a main body of a slot nozzle spray portion as well as forming a uniform coating layer, in contrast to such as polytetrafluoroethylene and polychlorotrifluoroethylene, which can be coated only in a powder or dispersion medium form. A concentration of a fluorine-containing polymer in a coating solution is in a range of 0.01-7 weight %.

As a fluorine type organic solvent utilized for fluorine-containing silane coupling agents described above, preferably utilized is such as Novec HFE, and as a fluorine type organic solvents utilized for amorphous fluorine-containing resin, preferably utilized are such as Silane Florinate, Novec HFE (these are manufactured by 3M Corp.), Garden (manufactured by Montefuluos Corp.), trifluoromethylbenzene and hydrofluorocarbon.

As a coating method of a fluorine-containing polymer against a main body of a slot nozzle spray portion, coating methods commonly known can be applied, and preferably utilized by appropriate selection can be such as a dipping method, a spray coat method, a spin coat method, a transfer method and an evaporation method.

A coating amount of a fluorine-containing polymer on a main body of a slot nozzle spray portion is not specifically limited provided it is in a range to realize a desired contact angle against water, however, is generally 0.001-0.1 g/m² and preferably 0.001-0.01 g/m² in the case of utilizing a fluorine-containing silane coupling agent, and is generally 0.01-10.0 g/m² and preferably 0.01-1.0 g/m² in the case of utilizing an amorphous fluorine-containing resin.

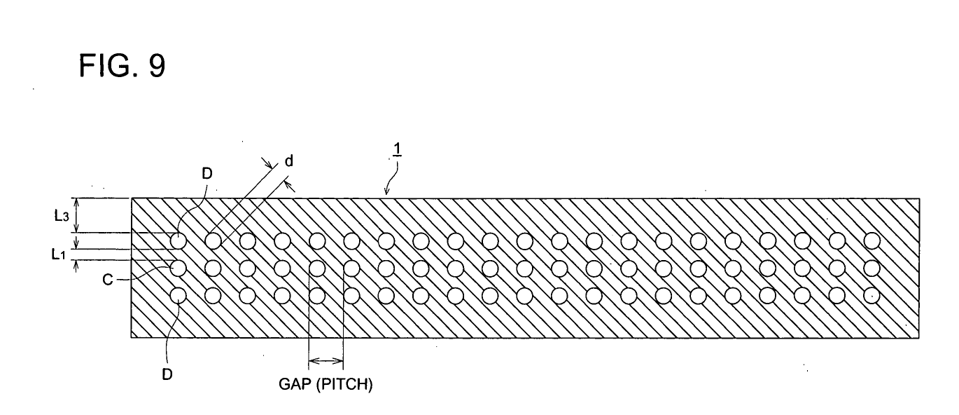

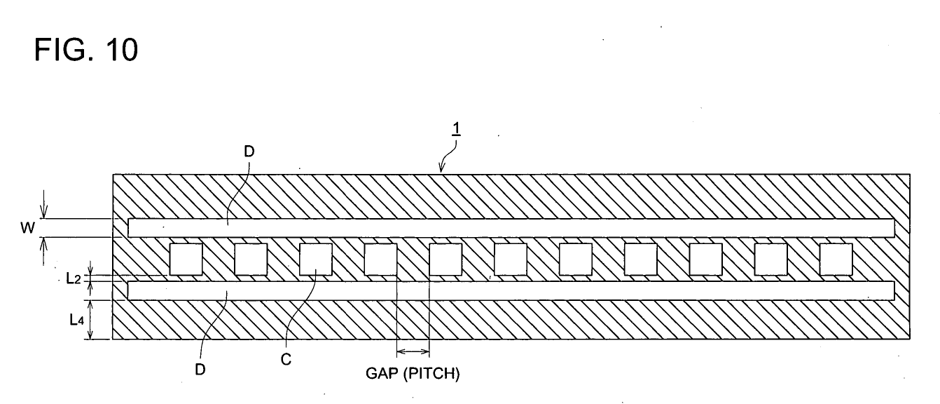

FIG. 9 and FIG. 10 are schematic drawings of the slot nozzle spray portion of FIG. 2 viewed from coating solution nozzle C side, and show a plural number of opening edges of coating solution nozzle C and of opening edges of gas nozzle D.

In a coating solution nozzle shown in FIG. 9, 21 pieces of coating solution nozzles C provided with a circular opening edge are arranged in rows in the coating width direction. And, it is an embodiment provided with gas nozzles D adjacent to and on the both sides of an opening edge of each coating solution nozzle C. Coating solution nozzles C each are arranged at same intervals, and, similarly, gas nozzles D each are also arranged at same intervals. Herein, one coating solution nozzles C and corresponding two gas nozzles D are arranged in a straight line perpendicular to the coating width direction, however, coating solution nozzles C and gas nozzles D may be arranged one after another in a zigzag manner. The intervals (pitches) of the opening edges of coating solution nozzles C or the opening edges of gas nozzles D are preferably constant.

A coating solution nozzle shown in FIG. 10 is provided with a different form from that described in FIG. 9. Coating solution nozzles of 11 pieces, provided with a rectangular opening edge, are arranged in a row in the coating width direction, and each one of gas nozzles D having a slit form is provided adjacent on the both side of the opening edges over the coating width for all coating solution nozzles C. In this embodiment, a plural number of rectangular openings of coating solution nozzles are also arranged at same intervals.

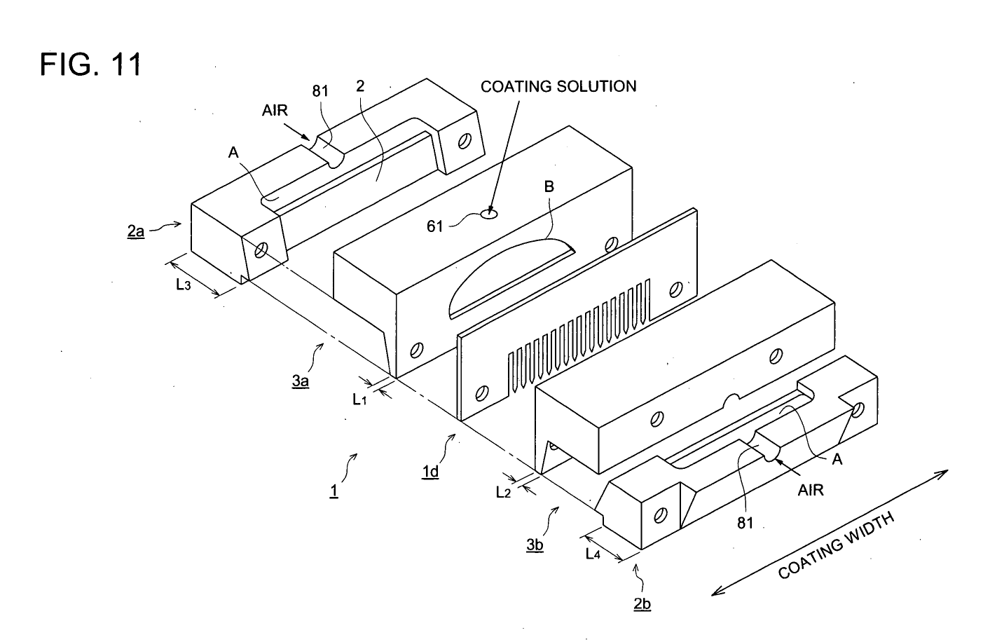

FIG. 11 is a detailed oblique view drawing of a slot nozzle spray portion provided with the coating solution nozzle of FIG. 9 type. In the drawing, reference symbols 3a and 3b, which form a coating solution slit-provided with a predetermined distance, are inner die blocks to flow a coating solution into said slit. One die block 3a is provided with coating solution supplying pipe 61, which receives a coating solution from a coating solution-supplying source being not shown in the drawing and reaches coating solution pocket B. A coating solution having stayed in coating solution pocket B flows down through the coating solution slit formed between inner die blocks 3a and 3b. 1d is a shim sandwiched by two die blocks 3a and 3b, and divides the coating solution slit, which is formed at a gap between two die blocks 3a and 3b, in the vertical direction to form a plural number of coating solution nozzles along the coating width direction.

On the other hand 2a and 2b are outer die blocks for gas supply and form gas nozzle D (being not shown in the drawing), through which a compressed gas flows, in a gap between each outer die blocks 2a and 2b, and corresponding inner die blocks 3a and 3b respectively. In this case, gas nozzle D is a slit spreading in the coating direction. A compressed gas is supplied from an air supplying source, being not shown in the drawing, to air supply tube 81 of each of outer die blocks 2a and 2b, and flows down by pressure through gas nozzle D (being not shown in the drawing) which is formed in the gaps between inner die blocks and outer die blocks after staying once in a gas pocket.

A coating solution flowing down through the above-described shim 1d, and a compressed gas which flowing down through two gas nozzles, collide at a coating solution nozzle to form liquid drops, which fly onto a member to be coated that is an object to be coated.

In a slot nozzle spraying apparatus utilized in this invention, the shape of an opening edge of a coating solution nozzle may be either circular or rectangular, and the size utilized is in a range of 50-300 μm while their pitches (intervals) are preferably set to 100-3000 μm. On the other hand, the shape of an opening edge of a gas nozzle may be either circular or of a slit form extending in the coating direction, and in this case, a diameter of circles (being shown by d in fig. 9) or a slit gap (being shown by w in FIG. 10) is generally in a range of 50-500 μm. An angle of a gas nozzle against a coating solution nozzle is preferably in a range of 15-60° and more preferably 15-45°. Further, a distance (L5 in FIG. 5) between a coating solution nozzle and a member to be coated in a slot nozzle spray portion is generally preferably in a range of 0.2-10 cm, more preferably 0.5-6.0 cm and furthermore preferably 1.0-3.5 cm.

A supply amount of a coating solution from a coating solution nozzle is not indiscriminately specified depending on such as a desired coating thickness, a concentration of a coating solution and a coating speed, however, is generally preferably in a range of 1-50 g/m² as a coating amount on a member to be coated. A stable and uniform coating layer is hardly formed when it is less than 1 g/m² while an effect on drying load is noticed when it is over 50 g/m², which results in difficulty of exhibition of the effects of this invention. A wet layer thickness of a coating solution is preferably 1-50 μm and more preferably 5-30 μn.

On the other hand, a gas gushed from a gas nozzle is any one provided being suitable for coating and air is generally utilized. As supplying conditions of a gas, preferable is a range of 1-50 CMM/m (a flow volume per coating width), and an internal pressure in a gas nozzle at this time is preferably not less than 10 kPa with respect to coating uniformity.

Air line velocity v is preferably 100-400 m/s with respect to effectively achieving the objective of the invention. Particularly, v is preferably not less than 100 m/s with respect to coating and drying properties, while v is preferably not more than 400 m/s with respect to a coating yield.

An air line velocity referred in this invention is an air line velocity immediately after the gas nozzle outlet, and can be determined by being measured by use of a laser Doppler anemometer, such as ID FLV System 8851 manufactured by Kanomax Corp. Further, a coating yield is (an amount of a coating solution coated on a member to be coated)/(a total amount of a coating solution supplied)×100(%), and calculated by a weight method. That is, an amount of a coating solution coated on a member to be coated can be calculated from the weight change from before to after coating on a member to be coated, while a total amount of a coating solution supplied can be determined from the weight having been sent and supplied to a coating solution nozzle, that is, (a supply flow rate)×(coating time).

Further, a mean particle diameter of liquid drops of a coating solution at this time is preferably 10-70 μm with respect to effectively achieving the objective of this invention. A mean particle diameter of liquid drops referred in this invention is a mean particle diameter at a coating gap (distance L5 between a coating solution nozzle and a member to be coated) position, and can be determined by being measured by use of a laser diffraction type particle size analyzer, such as RTS 114 manufactured by Malvan Corp.

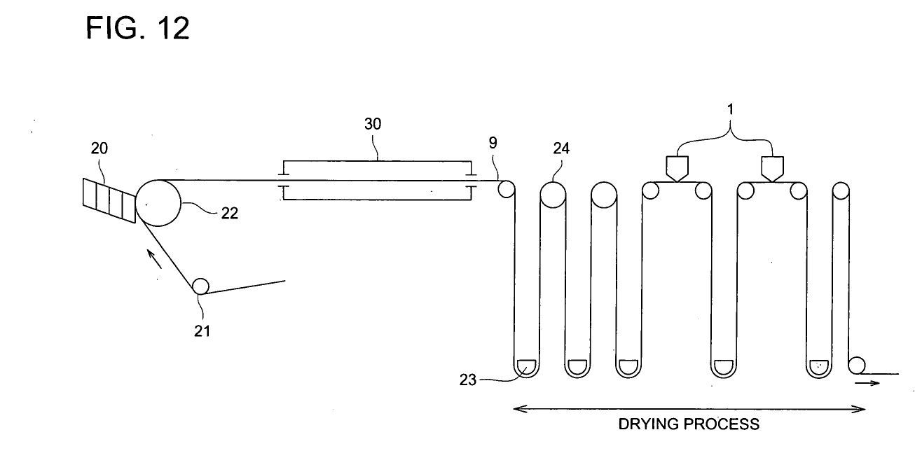

FIG. 12 shows an example of a coating manufacturing line in which a slot nozzle spraying apparatus such as explained above is arranged, and herein, a support coated with a constituent layer is utilized as a member to be coated. After said constituent layer had been coated, a plural number (in multi steps) of slot nozzle spraying apparatuses were arranged in a process for drying said constituent layer. To perform formation of a constituent layer and coating of an over coat layer (the uppermost layer) in the same line in this manner is called as on-line coating.

A support is transported from a master roll passing transport roller 21 and further turn-around transported at back-up roll 22, by a transport means being not shown in the drawing, where a coating solution for a porous ink absorptive layer (a constituent layer), which is supplied from slide bead coating apparatus 20 of a flow quantity control type, is coated. Since this coating solution for a porous ink absorptive layer contains a hydrophilic binder, it is fixed by being cooled once in cooling zone 30. Member 9 to be coated provided with a constituent layer on a support is transported to a drying process. In the drying process, reverser 23, which performs reversing transport by blowing air without contacting with the coated layer surface, and ordinary transport roller 24, which performs transport contacting with the back surface of member 9 to be coated, for transportation are arranged by turns to weaving transport member 9 to be coated. In this drying process, drying is performed by blowing a warm wind (a means to blow a warm wind is not shown in the drawing). In the way of this drying process, preferably at a position after a falling rate drying zone, coating is performed by use of two slot nozzle spraying apparatuses 1 by means of liquid drop spray of this invention which has been explained above. At least one of two slot nozzle spraying apparatuses is preferably mounted at a position after the drying end point with respect to a drying property. Herein, two slot nozzle spraying apparatuses are utilized. However, naturally one apparatus or not less than three apparatuses may be utilized. It has been proved that by performing coating by means of liquid spray dividing into plural steps, drying load is further reduced as well as uniformity of layer thickness is increased.

A coating speed to form a thin layer on a member to be coated by employing a coating method of this invention varies depending on such as a type, a concentration and a solvent content of a utilized coating solution, and a drying capability, and can not be indiscriminately specified, however, is preferably 50-500 m/min and more preferably 100-300 m/min.

The timing to perform coating by use of a coating method of this invention on a member to be coated, in which a support is provided with at least one constituent layer, is after falling rate drying of the constituent layer formed on a support and preferably after the end point of drying. Further, a coating process to perform coating of the aforesaid constituent layer by means of such as slide bead coating and a coating process to perform coating by utilizing a slot nozzle spraying apparatus of this invention are preferably performed successively in the same manufacturing line (on line coating). Since a coating method according to this invention is possible even with a small quantity of a coating solution, a drying load is small even when the coating is performed before said constituent layer is completely dried and there caused no bad effect on said constituent layer. Further, it has been proved that demerits such as cracks can be rather prevented when this coating is performed before said constituent layer is completely dried.

A coating method of this invention can be performed in a drying process of a constituent layer due to the small drying load. In the drying process, drying is, in general, preferably performed by blowing a drying wind which is controlled to a specific temperature and humidity from the front surface or from the backside surface, while a coated layer in a wet state is continuously transported.

A drying process of a coated layer in a wet state can primarily be classified as follows. An initial stage of drying is called as a constant rate drying section in which the surface temperature of a constituent layer is almost constant because water or a solvent as a dissolving medium of a coating solution is evaporated while taking latent heat of vaporization away. After a constant rate drying section, the surface temperature is raised because energy to release the interaction other than the latent heat of vaporization is required to evaporate water or a solvent having an interaction with a solute of a coating solution. This term is called as a falling rate drying section. A falling rate drying is a phenomenon happening when evaporation of a solvent from the surface is faster than water migration in a coated layer. Next, after finishing a falling rate drying, the process goes into a region in which the temperature of drying air and the surface temperature of an inkjet recording sheet coincide. The moment is called as an end point of drying.

A method to identify a constant rate drying section, a falling rate drying section and an end point of drying is not specifically limited, and, for example, monitoring the surface temperature enables to determine the region in which the surface-temperature is constant as a constant rate drying section, the region in which the surface temperature rises as a falling rate drying section and the moment when the surface temperature becomes equal to the drying temperature as an end point of drying. Further, as another method, it is possible to define the region where a reduction curve of water content becomes flat as an end point of drying by installing a water content meter in each region to monitor a water content of a coated layer.

A viscosity of a coating solution in a coating method of this invention is preferably 0.1-250 mPa·s, more preferably 0.1-50 mPa·s and furthermore preferably 0.1-20 mPa·s.

A coating method of this invention can uniformly form a thin layer, and is applicable to wide range of fields, such as providing a functional layer on the uppermost surface of a general silver salt light-sensitive material, forming an anti-reflection film, coating of a charge generating layer or a charge transporting layer of a photoreceptor utilized for electrophotography, and coating on an inkjet recording sheet. However, it is specifically preferably applied for coating of an over-coat layer on an inkjet recording sheet.

An inkjet recording sheet, to which a coating method of this invention is preferably applied, is provided with a porous ink absorptive layer containing a hydrophilic binder and micro-particles as a constituent layer on a support, and an over-coat layer is provided on said constituent layer by a coating method of this invention. A porous ink absorptive layer is primarily comprised of micro-particles and a hydrophilic binder. Preferably utilized are such as micro-particle silica synthesized by a gas phase method as micro-particles and such as polyvinyl alcohol as a hydrophilic binder. As a support utilized in such an inkjet recording sheet, a water-absorptive support (such as paper) and a water non-absorptive support can be utilized, however, a water non-absorptive support is preferred with respect to obtaining a higher quality print. Such a support includes a paper support in which the both side of paper are laminated with polyolefin resin.

A coating solution for a porous ink absorptive layer containing polyvinyl alcohol and micro-particle silica described above is liable to have low viscosity at high temperature and high viscosity at low temperature. Therefore, it is preferable to greatly increase the viscosity by cooling the coating solution after the aforesaid water-soluble coating solution having been coated on a support.

The coating temperature of a porous ink absorptive layer is generally 30-60° C. and the cooling temperature after coating can be controlled so as to make the coated layer temperature of approximately not higher than 20° C. and specifically preferably of not higher than 15° C.

A cooling process can be performed by passing the coated material through a zone cooled at not higher than 15° C. for a predetermined time (preferably for not shorter than 5 seconds). During this cooling time, it is preferable not to blow a too strong wind, with respect to obtaining a coated layer which does not cause wet wrinkles and is provided with uniformity but no unevenness. After once having been cooled, the coated layer hardly causes wet wrinkles due to an increased viscosity of a coating solution itself even being blown with a strong wind, so that wet wrinkles are restrained even under blowing of a strong wind. Further, the temperature of a strong wind blown can be not lower than 20° C., however, is preferably raised gradually.

The drying process after a porous ink absorptive layer having been coated on a support is performed by being blown with a wind, by being passed through a high temperature zone, or by these both methods in combination. In the case of being passed through a high temperature zone, the temperature is set at 50-150° C. In this case, the drying temperature is preferably selected to be suitable in consideration of heat resistance of a support and prevention of harmful effects on a coated layer. The relative humidity of a drying wind is generally 10-50% and preferably 15-40%. The drying time varies depending on the wet layer thickness, however, is generally within 10 minutes and specifically preferably within 5 minutes.

The coating speed depends on a wet layer thickness and a drying capacity, however, is generally 10-1000 m and preferably 20-500 m, per minute.

A coating method of a coating solution for a porous ink absorptive layer described above can be selected from methods commonly known, and preferably utilized are a gravure coating method, a roll coating method, a rod-bar coating method, an air-knife coating method, an extrusion coating method, a curtain coating method or an extrusion coating method employing a hopper described in U.S. Pat. No. 2,681,294.

Next, explained will be a coating solution for said over-coat layer in the case of providing an over-coat layer on a porous ink absorptive layer of an inkjet recording sheet by use of a slot nozzle spraying apparatus of this invention.

A coating solution for an over-coat layer is characterized by containing a function-providing compound for the constituent layer surface of an inkjet recording sheet. The function-providing compounds include such as organic or inorganic acids or various types of alkaline additives to vary the pH, water-soluble salts of polyvalent metal ions, various types of surfactants of an anionic, cationic, amphoteric or nonionic type, anti-fading agents, cationic fixing agents and cross-linking agents for a hydrophilic binder.

Acids utilized for the purpose of lowering the surface pH of a porous ink absorptive layer include, for example, inorganic acids such as sulfuric acid, hydrochloric acid, nitric acid and phosphoric acid; and an organic acids such as citric acid, formic acid, acetic acid, phthalic acid, succinic acid, oxalic acid and polyacrylic acid. Alkalis utilized for the purpose of increasing the surface pH of a porous ink absorptive layer include, for example, sodium hydroxide, potassium hydroxide, sodium carbonate, potassium carbonate, borax, sodium phosphate, potassium hydroxide and organic amines. These pH controlling agents specifically preferably utilized when a pH of a coating solution for porous structure formation is different from the preferable surface pH of a recording medium.

The surface pH of a porous ink absorptive layer of a recording sheet varies depending on the types of ink, and, since there is generally a tendency of water resistance and anti-bleeding of dyes being improved at more acidic side while light-fastness being improved at higher pH side, selected is the optimum pH in combination with ink utilized. The surface pH of a porous layer surface is preferably 3-7 and specifically preferably 3.5-6.5. The surface pH referred here is a value measured according to a surface pH measurement method of paper defined in J. TAPPI 49, and specifically, a value measured by dropping 50 μl of pure water (pH=6.2-7.3) on the recording sheet surface by use of a plane electrode available on the market.

The function-providing compound described above may be a surfactant. A surfactant can control a dot diameter at the time of inkjet recording, and includes an anionic, cationic, amphoteric or nonionic surfactant. Further, a surfactant can be utilized also in combination of two or more types. The addition amount of a surfactant is generally 0.01-50.0 mg per 1 m² of a recording medium. When it exceeds 50 mg, easily caused is mottled unevenness at the time of ink-jet recording.

The function-providing compound described above may be a cross-linking agent for a hydrophilic binder. As such a cross-linking agent, those commonly known can be utilized and preferable are boric acids, zirconium salts, aluminum salts or epoxy type cross-linking agents, described above.

The function-providing compound described above may be an image stabilizer (hereinafter also referred to as an anti-fading agent). An anti-fading agent restrains fading due to light irradiation and fading due to ozone, active oxygen, and various types of oxidizing gases such as NO₂ and SO₂.

As the function-providing compound described above, utilized can be a cationic polymer. Generally, a cationic polymer functions as a fixing agent for a dye and is preferably added in a coating solution which forms a porous receiving layer in advance, however, may be supplied by an over-coating method in the case of problems being caused when it is added in the coating solution. For example, it is preferably supplied by an over-coating method in the case of a viscosity the coating solution being increased or a coloring property being improved by providing a distribution of a cationic polymer within a porous layer. In the case of a cationic polymer is supplied by an over-coating method, the amount is generally 0.1-5.0 g per 1 m² of a recording sheet.

The function-providing compound described above may be a water-soluble polyvalent metal compound. Generally, since a water-soluble polyvalent metal compound is liable to be aggregated, when being present in a coating solution containing inorganic micro-particles, which induces minute coating defects and decrease of glossiness, it is specifically preferable to be supplied by an over-coating method. Such a polyvalent metal compound includes, for example, a sulfate, a chloride, a nitrate and a acetate of such as Mg₂⁺, Ca₂^{+, Zn}₂⁺, Zr₂⁺, Ni₂⁺ and Al₃⁺.

Each function-providing compound described above can be utilized alone or in combination of two or more types. Specifically, utilized can be an aqueous solution containing two or more types of anti-fading agents, a solution containing an anti-fading agent and a cross-linking agent, and a solution containing an anti-fading agent and a surfactant; and further a cross-linking agent, a water-soluble polyvalent metal compound and an anti-fading agent can be utilized in combination.

A solvent of the function-providing compounds described above can be water or a mixed solution of water and a water-miscible organic solvent, and water is specifically preferably utilized. Further, a mixed solution of water and a water-miscible low boiling point organic solvent (such as methanol, ethanol, i-propanol, n-propanol, acetone and methyl ethyl ketone) is also a preferable solvent. When water and a water-miscible organic solvent are utilized together, the containing ratio of water is preferably not less than 50 weight %. Herein, a water-miscible low boiling point organic solvent refers to an organic solvent having a solubility to water at room temperature of not less than 10 weight % and a boiling point of not higher than approximately 120° C. The surface tension of a coating solution utilized in a coating method of this invention is preferably 20-60 mN/m at room temperature, with respect to obtaining a uniform coating property.

In the following, this invention will be explained specifically referring to examples, however, is not limited thereto.

### EXAMPLE 1

Preparation of Member 1 to be Coated

Member 1 to be coated is prepared by forming a porous ink absorptive layer, which is constituted of 4 layers, as a constituent layer on a support.

[Preparation of Support]

Low density polyethylene having a density of 0.92 was coated at a thickness of 35 μm by an extrusion coating method on the back side surface of a paper substrate for photography having a moisture content of 6% and a basis weight of 200 g/m². Next, low-density polyethylene containing 5.5% of anatase type titanium dioxide and having a density of 0.92 was coated at a thickness of 40 μm by an extrusion coating method on the front side surface, resulting in a preparation of a support the both surfaces of which are covered with polyethylene. An under-coat layer comprising polyvinyl alcohol was coated to make 0.03 g/m² on the front side after having been subjected to corona discharge as well as a latex layer was coated to make 0.12 g/m² on the back side after having been subjected to corona discharge.

[Preparation of Each Dispersion]

(Preparation of Silica Dispersion 1)

Silica by a gas phase method having a mean particle diameter of the primary particles of 12 nm (Reoloseal QS-20, manufactured by Tokuyama Corp.) of 160 kg was suction dispersed in 480 L of pure water (containing 10 L of ethanol), pH of which was adjusted to 2.5, at room temperature by use of Jet Stream Inductor Mixer TDS, manufactured by Mitamura Riken Industrial Co., Ltd., followed by making the total amount of 600 L with pure water, resulting in preparation of silica dispersion 1.

(Preparation of Silica Dispersion 2)

Silica dispersion 1 described above of 60.0 L was added with stirring to 15 L of an aqueous solution (pH=2.3) containing 2.12 kg of a cationic polymer (HP-1), 2.2 L of ethanol and 1.1 L of n-propanol, followed by addition of 8.0 L of an aqueous solution containing 320 g of boric acid and 190 g of borax, and 200 ml of an aqueous solution containing 2 g of a defoaming agent SN381 manufactured by Sannopco Co., Ltd. was added. This mixed solution was dispersed by a high pressure homogenizer manufactured by Sanwa Industrial Co., Ltd., and the total volume was made up to 85 L with pure water, resulting in preparation of silica dispersion 2. 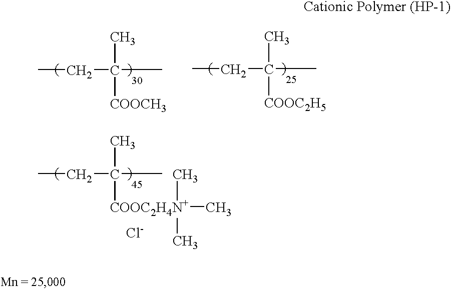
(Preparation of Oil Dispersion)

Diisodecylphthalate of 20 kg and an anti-oxidant (AO-1) of 20 kg were dissolved with heating in 45 kg of ethyl acetate, and the resulting solution was mixed with 210 L of a gelatin aqueous solution containing 8 kg of acid processed gelatin, 2.9 kg of a cationic polymer HP-1 and 5 kg of saponin at 55° C. and dispersed by a high pressure homogenizer, followed by being made up to 300 L with pure water, resulting in preparation of an oil dispersion. 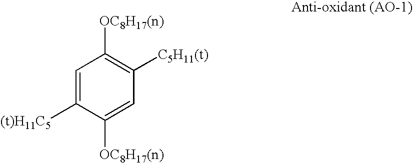
[Preparation of Coating Solution for Ink Absorptive Layer]

Each coating solution for an ink absorptive layer comprising the following constitutions was prepared. Herein, an addition amount in each layer was represented by an amount per 1 L of a coating solution. In examples, “%” represents weight % unless otherwise mentioned.

<Coating Solution for First Layer: Undermost Layer>

| | |
|---|---|
| Silica dispersion 2 | 580 ml |
| Polyvinyl alcohol (PVA203, manufactured by Kuraray Co., | 5 ml |
| Ltd.) 10% aqueous solution | |
| Polyvinyl alcohol (mean polymerization degree: 3800, | 290 ml |
| saponification degree of 88%) 6.5% aqueous solution | |
| Oil dispersion | 30 ml |
| Latex dispersion (AE803, manufactured by Showa Polymer | 42 ml |
| Co., Ltd) | |
| Ethanol | 8.5 ml |

The total volume is made up to 1000 ml with pure water.

<Coating Solution for Second Layer>

| | |
|---|---|
| Silica dispersion 2 | 600 ml |
| Polyvinyl alcohol (PVA203, manufactured by Kuraray Co., | 5 ml |
| Ltd.) 10% aqueous solution | |
| Polyvinyl alcohol (mean polymerization degree: 3800, | 270 ml |
| saponification degree of 88%) 6.5% aqueous solution | |
| Oil dispersion | 20 ml |
| Latex dispersion (AE803, manufactured by Showa Polymer | 22 ml |
| Co., Ltd) | |
| Ethanol | 8 ml |

The total volume is made up to 1000 ml with pure water.

<Coating Solution for Third Layer>

| | |
|---|---|
| Silica dispersion 2 | 630 ml |
| Polyvinyl alcohol (PVA203, manufactured by Kuraray Co., | 5 ml |
| Ltd.) 10% aqueous solution | |
| Polyvinyl alcohol (mean polymerization degree: 3800, | 270 ml |
| saponification degree of 88%) 6.5% aqueous solution | |
| Oil dispersion | 10 ml |
| Latex dispersion (AE803, manufactured by Showa Polymer | 5 ml |
| Co., Ltd) | |
| Ethanol | 3 ml |

The total volume is made up to 1000 ml with pure water.

<Coating Solution for Forth Layer: Uppermost Layer>

| | |
|---|---|
| Silica dispersion 2 | 660 ml |
| Polyvinyl alcohol (PVA203, manufactured by Kuraray Co., | 5 ml |
| Ltd.) 10% aqueous solution | |
| Polyvinyl alcohol (mean polymerization degree: 3800, | 250 ml |
| saponification degree of 88%) 6.5% aqueous solution | |
| 4% aqueous solution of a betaine type surfactant | 3 ml |
| 25% aqueous solution of saponin | 2 ml |
| Ethanol | 3 ml |

The total volume is made up to 1000 ml with pure water.

[Coating of Ink Absorptive Layer]

Next, each coating solution described above was 4-layer simultaneously coated so as to make the following wet thickness on the above-described support at 40° C., by a slide bead type coater employing a coating line comprising processes described in FIG. 12, resulting in preparation of member 1 to be coated.

(Wet Layer Thickness)

First Layer: 42 μm
Second Layer: 39 μm
Third Layer: 44 μm
Forth Layer: 38 μm

After coating of the ink absorptive layer coating solution, the temperature of the film surface was cooled down to 13° C. by being passed through a cooling zone kept at 5° C. for 15 seconds, then the layer was dried by being passed through each zone of drying process 30 while successively blowing windows of the following temperatures onto the ink absorptive layer surface. Herein, the total drying process was set to 360 seconds, and a mean relative humidity of a blowing wind was set to not more than 30% in the first 270 seconds. The drying process after 270 seconds was utilized as a rehumidufying zone having a relative humidity of 40-60%.

Application of Over-Coating

[Coating 101]

(Preparation of Over-Coat Solution 1)

An aqueous solution containing 1.0 weight % of the following water-soluble dye was prepared, which was designated as over-coat solution 1. 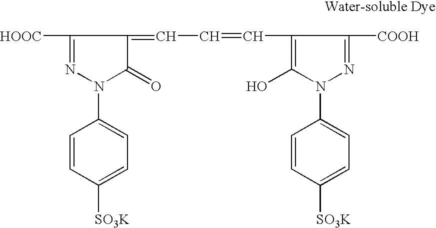
(Over-Coating)

Over-coat solution 1 prepared above was coated for continuous 5 minutes on member 1 to be coated prepared above at a coating speed of 100 m/min, so as to make wet layer thickness of 10.0 μm by use of a slot nozzle spraying apparatus in a coating line described in FIG. 12 (the latter half of the over-coat zone described in FIG. 12 was utilized and one set of coater was arranged), which was designated as coating 101. Herein, in a slot nozzle spraying apparatus utilized in coating 101, angle α formed by the bottom planes of outer die blocks was set to 160 degree, angle β formed between a coating solution ejecting outlet of a coating solution nozzle and a gas gushing outlet of a gas nozzle was set to 30 degree, each width L1 and L2 of the bottom planes of inner die blocks was set to 0.5 mm, each width L3 and L4 of the bottom planes of outer die blocks was set to 40 mm, and a distance between the bottom plane of outer die block and the surface of a member to be coated was set to 2 cm. Further, a gas supplied from a gas nozzle, employing air, was supplied at a wind velocity of 160 m/sec from the gas nozzle. Further, each gas nozzle shape utilized had a constitution described in FIG. 10, the opening edge of a coating solution nozzle being a rectangle of 120 μm square and the pitch being 1000 μm, and a gas nozzle constituted of a slit form of 200 μm width.

[Coatings 102-106]

Coatings 102-106 were performed in a similar manner to coating 101 described above, except that angles α formed by the bottom planes of outer die blocks were changed to 170 degree, 180 degree, 200 degree, 240 degree and 270 degree, respectively. Herein, an apparatus described in FIG. 5 was utilized as a slot nozzle spraying apparatus provided with the changed angles of 200 degree, 240 degree and 270 degree.

Evaluation Results of Coating Property

At the time of performing coatings 101-106 described above, the state of the bottom plane portion of a slot nozzle spraying apparatus, the flying state of a coating solution and the coated surface quality were visually observed to obtain the following results.

Coating 101 (α=160 Degree)

Over-coat solution liquid drops adhered and grew on bottom planes 2c and 2d of outer die blocks immediately after the start of coating, and made large liquid drops after 3 minutes from the start of coating and a spray intermittently flew resulting in generation of coating defects on the coated layer surface.

Coating 102 (α=170 Degree)

No over-coat solution liquid drops adhered on bottom planes 2c and 2d of outer die blocks resulting in a uniform coating property.

Coating 103 (α=180 Degree)

No over-coat solution liquid drops adhered on bottom planes 2c and 2d of outer die blocks resulting in a uniform coating property.

Coating 104 (α=200 Degree)

No over-coat solution liquid drops adhered on bottom planes 2c and 2d of outer die blocks resulting in a uniform coating property.

Coating 105 (α=240 Degree)

Landing ratio of over-coat liquid drops on a member to be coated was slightly decreased. However, no over-coat solution liquid drops adhered on bottom planes 2c and 2d of outer die blocks resulting in a uniform coating property.

Coating 106 (α=270 Degree)

Landing ratio of over-coat liquid drops on a member to be coated was significantly decreased, and a distribution of a landing volume (a coating volume) of the formed coating surface in a coating width direction was greatly deteriorated.

From the above results, it has been proved that a coating method of this invention, in which a slot nozzle spraying apparatus provided with angle α formed by the bottom planes of outer die blocks of 170-240 degree, exhibits excellent coating uniformity without adhesion of a liquid on the bottom planes of outer die blocks, compared to comparative examples.

### EXAMPLE 2

Coatings 201-204 were performed in a similar manner to coating 103 (α=180 degree, β=30 degree) described in example 1, except that angles β formed between a coating solution ejecting outlet of a coating solution nozzle and a gas gushing outlet of a gas nozzle were changed to 15 degree, 45 degree, 60 degree and 75 degree, respectively, and the state of the bottom plane portion of a slot nozzle spraying apparatus, the flying state of a coating solution and the coated surface quality were visually observed, together with coating 103 performed in example 1, to obtain the following results.

Coating 201 (β=15 Degree)

No over-coat solution liquid drops adhered on bottom planes 2c and 2d of outer die blocks resulting in a uniform coating property.

Coating 103 (β=30 Degree)

No over-coat solution liquid drops adhered on bottom planes 2c and 2d of outer die blocks-resulting in a uniform coating property.

Coating 202 (β=45 Degree)

No over-coat solution liquid drops adhered on bottom planes 2c and 2d of outer die blocks resulting in a uniform coating property.

Coating 203 (β=60 Degree)

The width of a spray of an over-coat solution was increased in the transport direction of a member to be coated and the landing ratio of over-coat liquid drops on a member to be coated was slightly decreased. However, a uniform coating property was obtained.

Coating 204 (β=75 Degree)

Landing ratio of over-coat liquid drops on a member to be coated was significantly decreased, and adhesion of over-coat solution drops on bottom planes 2c and 2d of outer die blocks was vigorous.

From the above results, it has been proved that a coating method of this invention, in which a slot nozzle spraying apparatus provided with angle β formed between a coating solution ejecting outlet of a coating solution nozzle and a gas gushing outlet of a gas nozzle of 15-60 degree, exhibits an excellent landing ratio (a coating efficiency) on a member to be coated and excellent coating uniformity without adhesion of a liquid on the bottom planes of outer die blocks, compared to comparative examples.

### EXAMPLE 3

Coatings 301-304 were performed in a similar manner to coating 103 (L1, L2=0.5 mm) described in example 1, except that each width L1 and L2 of the bottom planes of inner die blocks was changed to 0.05 mm, 1.0 mm, 1.5 mm and 2.0 mm, and coated surface quality was visually observed, together with coating 103 performed in example 1, to obtain the following results.

Coating 301 (L1, L2=0.05 mm)

No streak defects and spot defects are observed on the obtained coated layer surface.

Coating 103 (L1, L2=0.5 mm)

No streak defects and spot defects are observed on the obtained coated layer surface.

Coating 302 (L1, L2=1.0 mm)

Very weak random longitudinal streak unevenness is observed when the coated layer surface is precisely observed, however, no spot defects are observed, which is practically allowable quality.

Coating 303 (L1, L2=1.5 mm)

Strong longitudinal streak defects are caused on the coated layer surface, which is practically problematic quality.

Coating 304 (L1, L2=2.0 mm)

Strong spot defects are caused due to landing of coarse over coat solution drops that does not make a spray state, in addition that strong longitudinal streak defects are caused on the coated layer surface.

From the above results, it has been proved that a coating method of this invention, in which a slot nozzle spraying apparatus provided with each width L1 and L2 of the bottom planes of inner die blocks of not more than 1 mm, exhibits excellent coating uniformity without causing streak defects and spot defects, compared to comparative examples.

### EXAMPLE 4

As a result of performing over-coating in a similar manner to coatings 301-304 and coating 103, except that a slot nozzle spraying apparatus comprising inner die blocks of an arc form described in FIG. 6 is utilized instead of the apparatus described in FIG. 4, it has been confirmed similar to as described in example 3, that a coating method of this invention, in which a slot nozzle spraying apparatus provided with each width L1 and L2 of the bottom planes of inner die blocks is not more than 1 mm, exhibits excellent coating uniformity without generation of streak defects and spot defects, compared to comparative examples.

### EXAMPLE 5

Coatings 501-504 were performed in a similar manner to coating 103 (L3, L4=40 mm) described in example 1, except that each width L3 and L4 of the bottom planes of outer die blocks was changed to 1.0 mm, 10 mm, 50 mm and 60 mm, and the state of the bottom planes portion, the flying state of a coating solution and coated surface quality was visually observed, together with coating 103 performed in example 1, to obtain the following results.

Coating 501 (L3, L4=1.0 mm)

Slight adhesion of over-coat solution drops on the bottom planes 2c and 2d of outer die blocks was observed. However, nearly uniform coating property was obtained.

Coating 502 (L3, L4=10 mm)

No adhesion of over-coat solution drops on the bottom planes 2c and 2d of outer die blocks was observed and uniform coating property was obtained.

Coating 103 (L3, L4=40 mm)

No adhesion of over-coat solution drops on the bottom planes 2c and 2d of outer die blocks was observed and uniform coating property was obtained.

Coating 503 (L3, L4=50 mm)

Slight adhesion of over-coat solution drops on the bottom planes 2c and 2d of outer die blocks was observed. However, nearly uniform coating property was obtained.

Coating 504 (L3, L4=60 mm)

Over-coat solution liquid drops adhered and grew on bottom planes 2c and 2d of outer die blocks immediately after the start of over-coating, and made large liquid drops after 3 minutes from the start of coating and a spray intermittently flew resulting in generation of coating defects on the coated layer surface.

From the above result, it has been proved that a coating method of this invention, in which a slot nozzle spraying apparatus provided with each width L3 and L4 of the bottom planes of outer die blocks is in a range of 0.1-50.0 mm is utilized, exhibits excellent uniformity of a coating property without adhesion of a solution on the bottom planes of outer die blocks, compared to comparative examples.

### EXAMPLE 6

As a result of performing over-coating in a similar manner to coatings 501-504 and coating 103 described in above example 5, except that angle α formed by the bottom planes of outer die blocks was changed to 240 degree as described in FIG. 5, it has been confirmed that a coating method of this invention in which a slot nozzle spraying apparatus provided with each width L3 and L4 of the bottom planes of outer die blocks of in a range of 0.1-50 mm is utilized, exhibits excellent-coating uniformity without adhesion of a solution on the bottom of outer die blocks, compared to comparative examples.

### EXAMPLE 7

Coating 701-705 were performed in a similar manner to coating 203 (α=180 degree, β=60 degree) described in example 2, except that each width L1 and L2 of the bottom planes of inner die blocks was set to 0.1 mm, each width L3 and L4 of the bottom planes of outer die blocks was set to 3.0 mm, and distance L5 between the bottom plane of an outer die block and the surface of a member to be coated and distance L6 between the bottom plane of an inner die block and the surface of a member to be coated, described in FIG. 8, were set to as shown in table 1, and the coated surface quality (presence of spot defects) was visually observed. The obtained results are shown in table 1.

TABLE 1

| | | | ΔL (mm) | |
|---|---|---|---|---|
| Coating | L5 | L6 | (Absolute | |
| No. | (mm) | (mm) | value) | Observation results of coating |
| 701 | 20 | 24 | 4 | Liquid drops being not made |
| | | | | into micro-particles adhered |
| | | | | on a member to be coated and |
| | | | | slight spot unevenness |
| | | | | generated. |
| 702 | 20 | 22 | 2 | Flying of excellent micro |
| | | | | liquid drops was achieved and |
| | | | | coating uniformity was |
| | | | | excellent. |
| 703 | 20 | 20 | 0 | Flying of excellent micro |
| | | | | liquid drops was achieved and |
| | | | | coating uniformity was |
| | | | | excellent. |
| 704 | 20 | 18 | 2 | Flying of excellent micro |
| | | | | liquid drops was achieved and |
| | | | | coating uniformity was |
| | | | | excellent. |
| 705 | 20 | 16 | 4 | Liquid drops being not made |
| | | | | into micro-particles adhered |
| | | | | on a member to be coated and |
| | | | | slight spot unevenness |
| | | | | generated. |

It is clear from the result of table 1 that generation of spot defects can be restrained by setting difference ΔL between distance L5 between the bottom plane of an outer die block and the surface of a member to be coated, and distance L6 between the bottom plane of an inner die block and the surface of a member to be coated and a member to be coated, to be not more than 2 mm, which is a more preferable condition.

### EXAMPLE 8

As a result of coating in a similar manner to a coating method described in examples 17 described above, by utilizing each over-coat solution containing a pH controlling agent, a surfactant, a cross-linking agent for a hydrophilic binder, an image stabilizer and a water-soluble polyvalent metal compound, respectively, instead of an aqueous solution of a dye, it can be confirmed that a coating method of this invention, in which a slot nozzle spraying apparatus comprising the constitution defined in this invention is utilized, exhibits decreased streak unevenness and coating defects compared to comparative examples resulting in excellent coating uniformity, similar to the result described in above examples 1-7.

### EXAMPLE 9

Preparation of Member 2 to be Coated

[Preparation of Support]

A slurry solution containing 1 weight part of polyacrylamide, 4 weight parts of an ash component (talk), 2 weight parts of cationized starch, 0.5 weight parts of polamide epichlorohydrine resin per 100 weight of wood pulp (LBKP/NBSP=50/50) and alkylketene dimmers of various additives (a sizing agent) was prepared, and was made into a base paper so as to make a basis weight of 170 g/m² by use of a long net paper making machine. After the base paper has been subjected to a calendar treatment, one side of the base paper was covered with low density polyethylene resin having a density of 0.92, containing 7 weight % of anatase type titanium dioxide and a small amount of a color controlling agent at 320° C. so as to make a thickness of 28 μm by a fusing extrusion coating method, and the resulting product was cooled immediately by a mirror surface cooling roller. Next, the opposite side surface was covered with a fusing substance, in which (a high density polyethylene having a density of 0.96)/(a low density polyethylene having a density of 0.92)=70/30 were mixed, similarly by a fusing extrusion coating method so as to make a thickness of 32 μm. The titanium dioxide containing layer side was subjected to corona discharge followed by being coated with 0.05 g/m² of gelatin as a under-coat layer. While styrene/acryl type emulsion, containing silica micro-particles (matting agent) having a mean particle diameter of 1.0 μm and a small amount of a cationic polymer (conductive agent), was coated on the opposite side so as to make a dry layer thickness of 0.5 μm resulting in preparation of a support on which an ink absorptive layer is to be coated. The back surface side had a glossiness of approximately 18%, center line mean roughness Ra of 4.5 μm and a Beck's smoothness of 160-200 seconds. The water content of base paper of a support thus prepared was 7.0-7.2%.

[Preparation of Ink Absorptive Layer Coating Solution]

(Preparation of Titanium Dioxide Dispersion 1)

Titanium dioxide (W-10, manufactured by Ishihara Sangyo Kaisha Ltd.) having a mean particle diameter of approximately 0.25 μm of 20 kg was added to 90 L of an aqueous solution having a pH of 7.5 and containing 150 g of sodium tripolyphosphate, 500 g of polyvinyl alcohol (PVA235, manufactured by Kuraray Co., Ltd.), 150 g of cationic polymer (HP-1) and 10 g of a defoaming agent SN381, manufactured by Sannopco Co., Ltd, and the resulting solution was dispersed by High Pressure Homogenizer (manufactured by Sanwa Kogyo Co., Ltd) followed by being made up to 100 L to prepare homogeneous titanium dioxide dispersion 1.

(Preparation of Silica Dispersion 3)

| | |
|---|---|
| Water | 71 L |
| Boric acid | 0.27 kg |
| Borax | 0.24 kg |
| Ethanol | 2.2 L |
| Cationic polymer (HP-1) 25% aqueous solution | 17 L |
| Anti-fading agent (AF1 *1) 10% aqueous solution | 8.5 L |
| Fluorescent whitening agent (*2) | 0.1 L |

The total volume was made up to 100 L with pure water.
*1: Anti-fading agent (AF-1): HO-N(C₃H₄SO₃Na)₂
*2: Uvitex NFW Liquid, manufactured by Ciba Speciality Chemicals Inc.

Gas phase method silica (a mean primary particle diameter of approximately 12 nm) of 50 kg was prepared as inorganic micro-particles, which was added with the above-described additives and followed by being dispersed by the method described in example 5 of JP-A No. 2002-47454, resulting in preparation of silica dispersion 3.

(Preparation of Silica Dispersion 4)

Silica dispersion 4 was prepared in a similar manner to the preparation of silica dispersion 3 above described, except that cationic polymer (HP-1) was changed to cationic polymer (P-2). 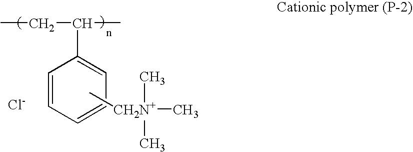
(Preparation of Ink Absorptive Layer Coating Solution)

Each ink absorptive layer coating solution of the first layer, the second layer, the third layer and the forth layer was prepared according to the following procedure.

(First Layer Coating Solution)
The following additives were successively mixed with
stirring at 40° C. into 610 ml of silica dispersion 3.

| | |
|---|---|
| Polyvinyl alcohol (PVA235, manufactured by Kuraray Co., | 220 ml |
| Ltd.) 5% aqueous solution | |
| Polyvinyl alcohol (PVA245, manufactured by Kuraray Co., | 80 ml |
| Ltd.) 5% aqueous solution | |
| Titanium dioxide dispersion | 30 ml |
| Polybutadiene dispersion (a mean particle diameter of 0.5 μm, | 15 ml |
| a solid content of 40%) | |
| Surfactant (SF1) 5% aqueous solution | 1.5 ml |

The total volume was made up to 1000 ml with pure water.

(Second Layer Coating Solution)
The following additives were successively mixed with
stirring at 40° C. into 630 ml of silica dispersion 3.

| | |
|---|---|
| Polyvinyl alcohol (PVA235, manufactured by Kuraray Co., | 180 ml |
| Ltd.) 5% aqueous solution | |
| Polyvinyl alcohol (PVA245, manufactured by Kuraray Co., | 80 ml |
| Ltd.) 5% aqueous solution | |
| Polybutadiene dispersion (a mean particle diameter of | 15 ml |
| 0.5 μm, a solid content of 40%) | |

The total volume was made up to 1000 ml with pure water.

(Third Layer Coating Solution)
The following additives were successively mixed with
stirring at 40° C. into 650 ml of silica dispersion 4.

| | |
|---|---|
| Polyvinyl alcohol (PVA235, manufactured by Kuraray Co., | 180 ml |
| Ltd.) 5% aqueous solution | |
| Polyvinyl alcohol (PVA245, manufactured by Kuraray Co., | 80 ml |
| Ltd.) 5% aqueous solution | |

The total volume was made up to 1000 ml with pure water.

(Forth Layer Coating Solution)

| | |
|---|---|
| The following additives were successively mixed with | 180 ml |
| stirring at 40° C. into 650 ml of silica dispersion 4. | |
| Polyvinyl alcohol (PVA235, manufactured by Kuraray Co., | |
| Ltd.) 5% aqueous solution | |
| Polyvinyl alcohol (PVA245, manufactured by Kuraray Co., | 80 ml |
| Ltd.) 5% aqueous solution | |
| Saponin 50% aqueous solution | 4 ml |
| Surfactant (SF1) 5% aqueous solution | 6 ml |
| The total volume was made up to 1000 ml with pure | |
| water. | |
| Surfactant (SF1) | |
| 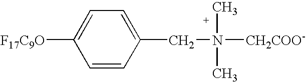 | |

Each coating solution prepared as described above was two-step filtered through a filter capable of 20 μm capturing. Every coating solution described above showed viscosity characteristics of 30-80 mPa·s at 40° C. and 30000-100000 mPa·s at 15° C.

(Coating of Ink Absorptive Layer)

Next, each coating solution described above was simultaneously coated so as to make the following wet layer thicknesses at 40° C. on the above support by use of a coating line comprising processes described in FIG. 12, employing a four-layer curtain coater at a coating width of approximately 1.5 m and a coating speed of 100 m/min.

Wet Layer Thickness

First Layer: 35 μm
Second Layer: 45 μm
Third Layer: 45 μm
Forth Layer: 40 μm

The coated ink absorptive layer was cooled immediately after coating of the coating solution in a cooling zone kept at 8° C. for 20 seconds, and followed by being dried at 20-30° C. and a relative humidity of not more than 20% for 30 seconds, at 60° C. and a relative humidity of not more than 20% for 120 seconds, and at 55° C. and a relative humidity of not more than 20% for 60 seconds, by blowing each drying wind. The film surface temperature at a constant rate drying region was 8-30° C., and after the film surface temperature was gradually raised in a falling rate drying region, rehumidifying was performed in a rehumidifying zone at 23° C. and a relative humidity of 40-60%, resulting in preparation of member 2 to be coated.

Preparation of Samples 901-903

[Preparation of Over-Coat Solution 2]

An aqueous solution containing 0.2 weight % of the above-described water-soluble dye was prepared and this was designated as over-coat solution 2. This over-coat solution 2 had a viscosity of 1.5 mPa·s at room temperature and a surface tension of 60-70 mN/m.

[Surface Water-Repellant Treatment]

Optool DSX (20 weight % solution, manufactured by Daikin Industrial Co., Ltd.) as a surface water-repellant treating agent was diluted with HFE 7100 (manufactured by 3M Corp.), resulting in preparation of a 0.1 weight % solution of Optool DSX. Next, by utilizing a slot nozzle spraying apparatus comprising the constitution described in FIG. 2 and FIG. 9, the 0.1 weight % solution of Optool DSX prepared above was uniformly coated on each bottom plane 2c and 2d of outer die blocks 2a and 2b, and each bottom plane 3d and 3c of inner die blocks 3a and 3b, at a solid coating amount of a fluorine containing polymer of 0.015 g/m² under conditions not to generate a non-coated portion, followed by drying at room temperature for 24 hours, resulting in a surface water-repellant treatment on the bottom portions of the slot nozzle spraying apparatus.

(Over-Coat)

Over-coat solution 2 prepared above was coated on an ink absorptive layer of the member to be coated prepared above, and dried, by use of the latter half over-coat zone of a coating line described in FIG. 12 and employing one set of a slot nozzle spraying apparatus having been subjected to the above-described water-repellant treatment. Herein, in a slot nozzle spraying apparatus, angle α formed by each bottom plane 2c and 2d of outer die blocks 2a and 2b described in FIG. 4 was set to 180 degree, angle β formed by a coating solution ejecting outlet of a coating solution nozzle and a gas gushing outlet of a gas nozzle was set to 30 degree, each width L1 and L2 of inner die blocks was set to 0.5 mm, each width L3 and L4 of outer die blocks was set to 40 mm, and a distance between the bottom plane of an outer die block and a member to be coated was set to 20 mm. Further, utilized was air as a gas supplied from a gas nozzle, and air was supplied from a gas nozzle at a wind velocity of 200 m/sec.

Preparation of Samples 904-906

Cytop 105P (manufactured by Asahi Glass Co., Ltd.) of 20 weight parts and CT-SOLV 100 (manufactured by Asahi Glass Co., Ltd.) of 80 weight parts as surface water-repellant treating agents were mixed and dissolved to prepare a 20 weight % solution of Cytop 105P. Next, by utilizing a slot nozzle spraying apparatus comprising the constitution described in FIG. 2 and FIG. 9, the 20 weight % solution of Cytop 105P prepared above was uniformly coated on each bottom plane 2c and 2d of outer die blocks 2a and 2b, and each bottom plane 3d and 3c of inner die blocks 3a and 3b, at a solid coating amount of a fluorine containing polymer of 1.0 g/m² under conditions not to generate a non-coated portion, followed by drying at 150° C. for 2 hours, resulting in a surface water-repellant treatment on the bottom portions of the slot nozzle spraying apparatus. Then, samples 904-906 were prepared in a similar manner to the preparation of samples 901-903, except that a slot nozzle spraying apparatus having been subjected to this water-repellant treatment was utilized.

Characteristics Evaluation of Each Sample

The following each evaluation was performed with respect to each inkjet recording sheet prepared according to the above-described method.

[Evaluation of Streak Defect Resistance]

The state of streak defects generation on the over-coat surface of each inkjet recording sheet prepared above was visually observed and evaluation of the streak defect resistance was performed according to the following criteria.

A: No streak defects are observed on the over-coat surface.

B: Some slight streak defects are observed on the over-coat surface. However, it is allowable in practical use.

C: Some strong streak defects are observed on the over-coat surface, which is problematic in practical use.

D: Significantly strong streak defects are observed on the over-coat surface, which is a quality not withstanding practical use.

Herein, streak defects refer to an uneven density of a streak form that generates density variation along the coating width direction.

[Evaluation of Cross Streak Defect Resistance]

The state of cross streak defects generation on the over-coat surface of each inkjet recording sheet prepared above was visually observed and evaluation of the cross streak defect resistance was performed according to the following criteria.

A: No cross streak defects are observed on the over-coat surface.

B: Some slight cross streak defects are observed on the over-coat surface, which is allowable in practical use.

C: Some strong cross streak defects are observed on the over-coat surface, which is problematic in practical use.

D: Significantly strong cross streak defects are observed on the over-coat surface, which is a quality not withstanding practical use.

Herein, cross streak defects refers to an uneven density which provides a higher and a lower densities at pitches of 1-3 cm in the coating longitudinal direction (a coating machine direction) of the coating surface.

Each evaluation results obtained above are shown in table 2.

TABLE 2

| | Surface water- | | | | Evaluation of | | |
|---|---|---|---|---|---|---|---|
| | repellant | | | | coating | | |
| | treatment | | | | uniformity | | |
| | Water- | Water- | | | | Cross | |
| | repellant | repellant | Coating | Wet | Streak | streak | |
| Sample | treatment | treating | speed | layer | defect | defect | |
| No. | position | agent | (m/min) | thickness | resistance | resistance | Remarks |
| 901 | Bottom | Optool DSX | 100 | 20 | A | A | Inv. |
| | plane | | | | | | |
| | portion | | | | | | |
| 902 | Bottom | Optool DSX | 250 | 10 | B | B | Inv. |
| | plane | | | | | | |
| | portion | | | | | | |
| 903 | Bottom | Optool DSX | 250 | 20 | B | B | Inv. |
| | plane | | | | | | |
| | portion | | | | | | |
| 904 | Bottom | Cytop | 100 | 20 | A | A | Inv. |
| | plane | | | | | | |
| | portion | | | | | | |
| 905 | bottom | Cytop | 250 | 10 | B | B | Inv. |
| | plane | | | | | | |
| | portion | | | | | | |
| 906 | Bottom | Cytop | 250 | 20 | B | B | Inv. |
| | plane | | | | | | |
| | portion | | | | | | |

Inv.: Invention

It is clear from the results described in table 2 that samples 901-906 prepared by coating employing a slot nozzle spraying apparatus, the bottom plane portion of which have been subjected to a surface water-repellant treatment, exhibits excellent coating uniformity regardless to conditions of a coating speed and a wet layer thickness at the time of coating. That is, it enables thin layer and high speed coating.

### EXAMPLE 10

Preparation of Samples 1001-1003

Samples 1001-1003 were prepared in a similar manner to the preparation of samples 901-903 described in example 9, except that a slot nozzle spraying apparatus having been subjected to the following water-repellant treatment.

The utilized slot nozzle spraying apparatus is comprised of the constitution described in FIG. 2 and FIG. 9, and a 0.1 weight % solution of Optool DSX prepared in example 9 was uniformly coated at a solid coating amount of a fluorine containing polymer of 0.015 g/m² under conditions not to generate a non-coated portion, on each bottom plane 2c and 2d of outer die blocks 2a and 2b, each bottom plane 3d and 3c of inner die blocks 3a and 3b, and flow passage walls of gas pocket A and gas nozzle D, and drying was performed at room temperature for 24 hours, resulting in a surface water-repellant treatment on each bottom surface, and on a gas passage wall of a gas nozzle.

Characteristics Evaluation of Each Sample

Each evaluation of streak defect resistance and cross streak defect resistance with respect to each ink-jet recording sheet prepared according to the above method was performed in a similar manner to the method described in example 9 and the obtained results are shown in table 3.

TABLE 3

| | Surface water- | | | | Evaluation of | | |
|---|---|---|---|---|---|---|---|
| | repellant | | | | coating | | |
| | treatment | | | | uniformity | | |
| | Water- | Water- | | Wet | | Cross | |
| | repellant | repellant | Coating | layer | Streak | streak | |
| Sample | treatment | treating | speed | thickness | defect | defect | |
| No. | position | agent | (m/min) | (μm) | resistance | resistance | Remarks |
| 1001 | Bottom | Optool DSX | 100 | 20 | A | A | Invention |
| | plane | | | | | | |
| | portion, | | | | | | |
| | gas flow | | | | | | |
| | passage | | | | | | |
| | wall | | | | | | |
| 1002 | Bottom | Optool DSX | 250 | 10 | A | B | Invention |
| | plane | | | | | | |
| | portion, | | | | | | |
| | gas flow | | | | | | |
| | passage | | | | | | |
| | wall | | | | | | |
| 1003 | Bottom | Optool DSX | 250 | 20 | A | A | Invention |
| | plane | | | | | | |
| | portion, | | | | | | |
| | gas flow | | | | | | |
| | passage | | | | | | |
| | wall | | | | | | |

It is clear from the results described in table 3 that an inkjet recording sheet of this invention prepared by use of a slot nozzle spraying apparatus, the bottom portion and the gas flow passage wall of which have been subjected to a surface water-repellant treatment, exhibits excellent coating uniformity regardless of conditions of a coating speed and a wet thickness at the time of coating.

### EXAMPLE 11

Preparation of Sample 1101

Sample 1101 was prepared in a similar manner to the preparation of sample 902 described in example 9, except that a slot nozzle spraying apparatus, having been subjected to the following water-repellant treatment, was utilized. The utilized slot nozzle spraying apparatus is comprised of the constitution described in FIG. 2 and FIG. 9, and a 0.1 weight % solution of Optool DSX prepared in example 9 was uniformly coated at a solid coating amount of a fluorine containing polymer of 0.015 g/m² under conditions not to generate a non-coated portion, on each bottom plane 2c and 2d of outer die blocks 2a and 2b, each bottom plane 3d and 3c of inner die blocks 3a and 3b, flow passage walls of gas pocket A and gas nozzle D, and flow passage walls of coating solution pocket B and coating solution nozzle C, and drying was performed at room temperature for 24 hours, resulting in a surface water-repellant treatment of each bottom surface, a gas passage wall of a gas nozzle and a coating solution flow passage wall.

Characteristics Evaluation of Each Sample

Each evaluation of streak defect resistance and cross streak defect resistance were performed with respect to sample 1101 prepared according to the above method and sample 1002 prepared in example 2 in a similar manner to the method described in example 9, and the obtained results are shown in table 4.

TABLE 4

| | Surface water- | | | | Evaluation of | | |
|---|---|---|---|---|---|---|---|
| | repellant | | | | coating | | |
| | treatment | | | | uniformity | | |
| | Water- | Water- | | Wet | | Cross | |
| | repellant | repellant | Coating | layer | Streak | streak | |
| Sample | treatment | treating | speed | thickness | defect | defect | |
| No. | position | agent | (m/min) | (μm) | resistance | resistance | Remarks |
| 1002 | Bottom | Optool DSX | 250 | 10 | A | B | Invention |
| | plane | | | | | | |
| | portion, | | | | | | |
| | gas flow | | | | | | |
| | passage | | | | | | |
| | wall | | | | | | |
| 1101 | Bottom | Optool DSX | 250 | 10 | A | A | Invention |
| | plane | | | | | | |
| | portion, | | | | | | |
| | gas flow | | | | | | |
| | passage | | | | | | |
| | wall, | | | | | | |
| | coating | | | | | | |
| | solution | | | | | | |
| | flow | | | | | | |
| | passage | | | | | | |
| | wall | | | | | | |

It is clear from the results described in table 4 that an inkjet recording sheet of this invention prepared by use of a slot nozzle spraying apparatus, in which the bottom portion, gas passage flow walls and coating solution flow passage walls were subjected to a water-repellant treatment, exhibits extremely excellent coating uniformity regardless conditions of a coating speed and a wet layer thickness at the time of coating.

### EXAMPLE 12

As a result of coating in a similar manner to the coating method described in above examples 9-11 except utilizing each over-coat solution containing a surfactant, a cross-linking agent for a hydrophilic binder, an image stabilizer and a water-soluble polyvalent metal compound, respectively, instead of a dye aqueous solution, and evaluating coating uniformity, it has been confirmed, similar to the result described in examples 9-11, that a coating method of this invention utilizing a slot nozzle spraying apparatus having been subjected to a surface water-repellant treatment defined in this invention exhibits decrease of coating defects such as streak defects and cross streak defects resulting in excellent coating uniformity, compared to comparative examples.

1. A coating apparatus comprising:
a slot nozzle spraying apparatus provided with a pair of inner die blocks and outer die blocks at the outside of said pair of inner die blocks, having a coating solution nozzle formed between said pair of inner die blocks, and gas nozzles constituted between one inner die block and outer die block adjacent thereto, and between another inner die block and outer die block adjacent thereto, wherein,
angle β between the solution flow passage of said coating solution nozzle and the gas flow passage of one of said gas nozzles is 15-60 degree.

2. A coating apparatus comprising:
a slot nozzle spraying apparatus provided with a pair of inner die blocks and outer die blocks at the outside of said pair of inner die blocks, having a coating solution nozzle formed between said pair of inner die blocks, and gas nozzles constituted between one inner die block and outer die block adjacent thereto, and between another inner die block and outer die block adjacent thereto, wherein,
angle α formed by planes of said outer die blocks located at the position opposing to a member to be coated is 170-240 degree.

3. A coating apparatus comprising:
a slot nozzle spraying apparatus provided with a pair of inner die blocks and outer die blocks at the outside of said pair of inner die blocks, having a coating solution nozzle formed between said pair of inner die blocks, and gas nozzles constituted between one inner die block and outer die block adjacent thereto, and between another inner die block and outer die block adjacent thereto, wherein,
each width of the planes of said pair of inner die blocks opposing a member to be coated is not more than 1 mm, and each width of the planes of said pair of outer die blocks opposing a member to be coated is 0.1-50 mm.

4. The coating apparatus of claim 1, wherein, the difference ΔL between, the distance between the plane of an outer die block and the surface of a member to be coated, and the distance between the plane of an inner die block and the surface of the member to be coated, is not more than 2 mm.

5. The coating apparatus of claim 1, wherein, by said slot nozzle spraying apparatus, a coating solution is coated on a member to be coated, which is transported, by a gas being collided with said coating solution to form liquid drops and performing spraying, over the coating width in the direction crossing the transport direction of said member.

6. The coating apparatus of claim 4, wherein,
by said slot nozzle spraying apparatus, a coating solution is coated on a member to be coated, which is transported, by a gas being collided with said coating solution to form liquid drops and performing spraying, over the coating width in the direction crossing the transport direction of said member.

7. The coating apparatus of claim 1, wherein, the surfaces adjacent to the ejection outlet of said coating solution nozzle and/or of said gas nozzles opposing to a member to be coated are subjected to a surface water-repellant treatment.

8. The coating apparatus of claim 4, wherein,
the surfaces adjacent to the ejection outlet of said coating solution nozzle and/or of said gas nozzles opposing to a member to be coated are subjected to a surface water-repellant treatment.

9. The coating apparatus of claim 7, wherein,
the gas flow passage wall of said gas nozzles and/or the solution flow passage wall of said coating solution nozzle are also subjected to a surface water-repellant treatment.

10. The coating apparatus of claim 8, wherein,
the gas flow passage wall of said gas nozzles and/or the solution flow passage wall of said coating solution nozzle are also subjected to a surface water-repellant treatment.

11. The coating apparatus of claim 7, wherein,
said surface water-repellant treatment is performed by coating a fluorine-containing polymer on the surfaces or the walls.

12. The coating apparatus of claim 8, wherein,
said surface water-repellant treatment is performed by coating a fluorine-containing polymer on the surfaces or the walls.

13. The coating apparatus of claim 5, wherein,
said member to be coated is an inkjet recording sheet provided with an ink absorptive layer.

14. The coating apparatus of claims 6, wherein,
said member to be coated is an inkjet recording sheet provided with an ink absorptive layer.

15. The coating apparatus of claim 13, wherein,
said coating solution is for an over-coat layer containing a function-providing compound for a constituent layer surface of said inkjet recording sheet.

16. The coating apparatus of claim 14, wherein,
said coating solution is for an over-coat layer containing a function-providing compound for a constituent layer surface of said inkjet recording sheet.

17. The coating apparatus of claim 15, wherein,
said function-providing compound is selected from a pH controlling agent, a surfactant, a cross-linking agent for a hydrophilic binder, an anti-fading agent, a fixing agents and a water-soluble salt of polyvalent metal ions.

18. The coating apparatus of claim 16, wherein,
said function-providing compound is selected from a pH controlling agent, a surfactant, a cross-linking agent for a hydrophilic binder, an anti-fading agent, a fixing agents and a water-soluble salt of polyvalent metal ions.
